(19) United States
(12) Patent Application Publication
(10) Pub. No.: US 2010/0149567 A1
(43) Pub. Date: Jun. 17, 2010

(54) Image forming apparatus and image forming method

(75) Inventors: Yukihiko Kanazawa, Kanagawa-ken (JP); Yoshiaki Inoue, Kanagawa-ken (JP); Hirofumi Saita, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/654,100

(22) Filed: Dec. 10, 2009

(30) Foreign Application Priority Data
Dec. 12, 2008 (JP) 2008-317538

(51) Int. Cl. H04N 1/60

(52) U.S. Cl. 358/1.9

(57) ABSTRACT

An image forming apparatus has: a recording head for forming an image on a recording medium; a color correction processing device which performs a color correction processing with respect to an input image data; an image output controller which controls the recording head according to the image data after performing the color correction processing in such a manner that the image corresponding to the image data is formed on the recording medium; a patch forming controller which controls the recording head so as to form a patch for colorimetry on the recording medium; a memory device for storing an output condition for forming the image, and measured results of the patch for colorimetry formed under the output condition; and a correction data change device which changes a correction data used for the color correction processing performed by the color correction processing device, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

### BACKGROUND OF THE INVENTION

1. Field of the Invention

The present invention relates to an image forming apparatus and an image forming method, and more particularly, to technology suitable for improving the stability and reproducibility of image quality in a liquid droplet ejection image forming apparatus based on the reaction of two or more liquids including a treatment liquid which insolubilizes or aggregates an ink.

2. Description of the Related Art

Japanese Patent Application Publication No. 2005-280343 discloses a composition in which, in order to maintain designed density and color hue in response to changes in characteristics due to deterioration over time of pressure generating elements with long-term use of an inkjet printer, or the like, a prescribed inspection pattern is read in by a scanner, a coloration bias in the sample coloration information with respect to reference coloration information is calculated, and the dot forming rate is adjusted on the basis of the results of this calculation.

Japanese Patent Application Publication No. 2006-305766 discloses a composition in which, in order to shorten the time taken by color control in response to color changes in an output image due to temporal change, ambient change, and the like, a determination image is recorded onto the same recording medium as an actual image, and this determination image is determined by a color sensor and the image forming conditions are controlled accordingly.

Japanese Patent Application Publication No. 2005-225075 discloses a composition in which, in order to obtain good color reproduction with respect to reference colors, the difference between colorimetric data of a patch for color correction and reference colorimetric data is obtained, and dot volume correction is carried out so as to compensate for color divergence.

However, none of Japanese Patent Application Publication No. 2005-280343, Japanese Patent Application Publication No. 2006-305766 and Japanese Patent Application Publication No. 2005-225075 makes reference to the stability of image quality (for example, color stability, density stability, and the like) within one printing step (one job), or makes mention of a device which improves reproducibility of image quality in the case of printing the same print content which has been printed in the past, again after time (years, months or days) has passed (namely, between print jobs).

In image forming apparatuses, such as printing machine, there is a possibility that image quality varies between jobs or within a job due to various factors. For example, there is a possibility that when repeating the printing of a printed object that has been output in the past, after the passage of time, then the image quality differs due to variation in the state of the printing machine as a result of temporal change or change in the ambient conditions, and the like. Furthermore, there is a problem of variation in the color non-uniformities (color differences) in one print job in which a plurality of sheets are output (problem of the stability during the same job).

### SUMMARY OF THE INVENTION

The present invention has been contrived in view of these circumstances, an object thereof being to provide an image forming apparatus and an image forming method which improve the stability of image quality during the same job and improve the reproducibility of image quality among jobs.

One aspect of the present invention is directed to an image forming apparatus comprising: a recording head for forming an image on a recording medium; a color correction processing device which performs a color correction processing with respect to an input image data; an image output controller which controls the recording head according to the image data after performing the color correction processing in such a manner that the image corresponding to the image data is formed on the recording medium; a patch forming controller which controls the recording head so as to form a patch for colorimetry on the recording medium; a memory device for storing an output condition for forming the image, and measured results of the patch for colorimetry formed under the output condition; and a correction data change device which changes a correction data used for the color correction processing performed by the color correction processing device, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

Desirably, the memory device stores, before starting of the printing job, the output condition under which the image having an intended image quality has been formed and the measured results of the patch for colorimetry formed under the output condition; and the patch for colorimetry is formed and the colorimetry of that formed patch is performed during performing the printing job, and the correction data is changed when the difference between the measured results of that performed colorimetry and the measured results stored in the memory device before starting of the printing job exceeds the predetermined acceptable range.

Desirably, the memory device stores the output condition for a particular printing job that has been performed previously and the measured results of the patch for colorimetry formed under that output condition; and the image and the patch for colorimetry are formed according to the output condition for the particular printing job stored in the memory device, and the correction data is changed when the difference between the measured results of that patch for colorimetry and the measured results stored in the memory device for the particular printing job that has been performed previously exceeds the predetermined acceptable range.

Desirably, the memory device stores the output condition and the measured results of the patch for colorimetry with respect to each printing job; and the image forming apparatus further comprises a search device which extracts information on a desired printing job from information stored in the memory device.

Desirably, the image forming apparatus further comprises: a reading device which reads the patch for colorimetry; and a colorimetry calculation processing device which performs the colorimetry according to an image read by the reading device.

Desirably, the correction data is one of a multi-dimension look-up table, a color conversion matrix coefficient and a one-dimension look-up table.

Desirably, the image forming apparatus further comprises a treatment liquid deposition device which deposits on the recording medium a treatment liquid insolubilizing or aggregating inks, wherein the recording head includes at least one inkjet head which ejects the inks with a plurality of colors onto the recording medium.

Desirably, the patch for colorimetry contains single-color patches and mixed-color patches that are formed repeatedly in terms of lateral and longitudinal directions with respect to a recording area of the recording medium.

Another aspect of the present invention is directed to an image forming method comprising: a color correction processing step of performing a color correction processing with respect to an input image data; an image output control step of controlling the recording head according to the image data after performing the color correction processing in such a manner that the image corresponding to the image data is formed on the recording medium; a patch forming control step of controlling the recording head so as to form a patch for colorimetry on the recording medium; a memory step of storing in a memory device an output condition for forming the image, and measured results of the patch for colorimetry formed under the output condition; and a correction data change step of changing a correction data used for the color correction processing performed in the color correction processing step, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

According to the present invention, it is possible to obtain stable image quality (color stability, density, etc.) in the same print job. Furthermore, according to the present invention, it is also possible to reproduce satisfactorily the image quality of a printed item obtained in a particular job which has been performed in the past.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a configuration diagram illustrating the whole of an inkjet recording device according to an embodiment of the present invention;

FIG. 2A is a plan view perspective diagram illustrating an example of the structure of a head; and FIG. 2B is an enlarged view of same;

FIG. 3 is a plan view perspective diagram illustrating a further example of the structure of a head;

FIG. 4 is a cross-sectional diagram along line 4-4 in FIGS. 2A and 2B;

FIG. 5 is an enlarged diagram illustrating a nozzle arrangement in the head illustrated in FIGS. 2A and 2B;

FIG. 6 is a schematic drawing of a liquid supply system;

FIG. 7 is a main part block diagram illustrating a system configuration of an inkjet recording device;

FIG. 8 is a schematic drawing of an in-line determination unit;

FIG. 9 is a flowchart showing an example of operation in an embodiment of the invention;

FIG. 10 is an illustrative diagram illustrating an example of forming a patch for colorimetry;

FIG. 11 is a main part block diagram relating to color correction and image output;

FIG. 12 is an illustrative diagram of color conversion when using a 4D-LUT as correction data;

FIG. 13 is an illustrative diagram used to explain one example of a 4D-LUT creation process;

FIG. 14 is a diagram illustrating one example of a matrix used as correction data;

FIG. 15 is an illustrative diagram used to explain color conversion when using a 1D-LUT as correction data; and

FIG. 16 is an illustrative diagram used to explain color conversion using differential correction data.

### DETAILED DESCRIPTION OF THE PREFERRED EMBODIMENTS

### Overall Structure of Inkjet Recording Apparatus

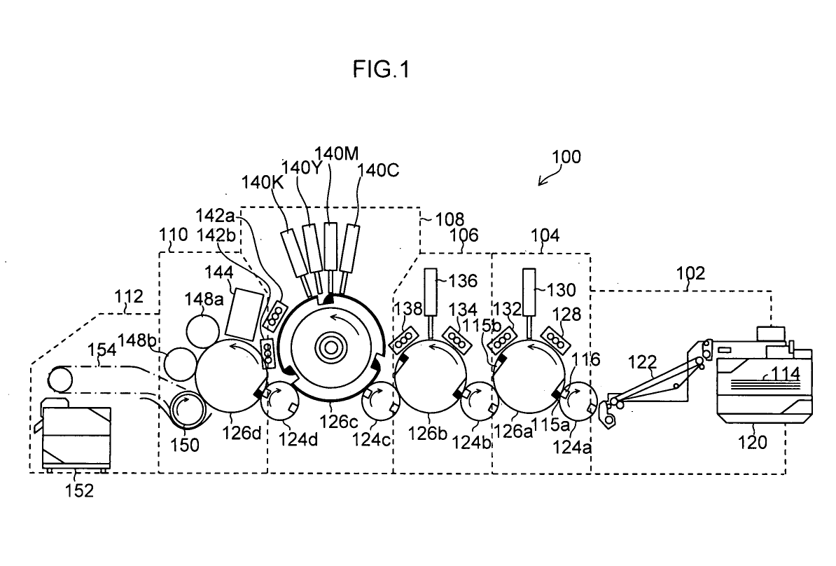

FIG. 1 is a schematic drawing of the composition of an inkjet recording apparatus 100 according to an embodiment of the present invention. The inkjet recording apparatus 100 adopts a pressure drum direct rendering system which directly deposits droplets of ink of a plurality of colors onto a recording medium (also referred to as “paper” for convenience) 114 held on a pressure drum 126c of an ink ejection unit 108 to form a desired color image, and is an on demand type image forming apparatus that uses the two liquid reaction (aggregation) system that uses the ink and treatment liquid (here, aggregation treatment liquid) to form images on the recording medium 114 of paper sheets.

The inkjet recording apparatus 100 principally includes: a paper supply unit 102 which supplies the recording medium 114; a permeation suppression agent deposition unit 104 which deposits permeation suppression agent on the recording medium 114; a treatment liquid deposition unit 106 which deposits treatment liquid onto the recording medium 114; an ink ejection unit 108 which ejects and deposits droplets of ink onto the recording medium 114; a fixing unit 110 which fixes an image recorded on the recording medium 114; and a paper output unit 112 which conveys and outputs the recording medium 114 on which an image has been formed.

A paper supply platform 120 on which recording media 114 is stacked is provided in the paper supply unit 102. A feeder board 122 is connected to the front of the paper supply platform 120 (the left-hand side in FIG. 1), and the recording media 114 stacked on the paper supply platform 120 is supplied one sheet at a time, successively from the uppermost sheet, to the feeder board 122. A recording medium 114 which has been conveyed to the feeder board 122 is supplied through a transfer drum 124a to a pressure drum (permeation suppression agent drum) 126a of the permeation suppression agent deposition unit 104.

Holding hooks (grippers) 115a and 115b for holding the leading edge of the recording medium 114 are formed on the surface (circumferential surface) of the pressure drum 126a, and the recording medium 114 that has been transferred to the pressure drum 126a from the transfer drum 124a is conveyed in the direction of rotation (the counter-clockwise direction in FIG. 1) of the pressure drum 126a in a state where the leading edge is held by the holding hooks 115a and 115b and the medium adheres tightly to the surface of the pressure drum 126a (in other words, in a state where the medium is wrapped about the pressure drum 126a). A similar composition is also employed for the other pressure drums 126b to 126d, which are described hereinafter. A member 116 for transferring the leading edge of the leading edge of the recording medium 114 to the holding hooks 115a and 115b of the pressure drum 126a is formed on the surface (circumferential surface) of the transfer drum 124a. A similar composition is also employed for the other transfer drums 124b to 124d, which are described hereinafter.

### Permeation Suppression Agent Deposition Unit

In the permeation suppression agent deposition unit 104, a paper preheating unit 128, a permeation suppression agent ejection head 130 and a permeation suppression agent drying unit 132 are provided respectively at positions opposing the surface of the pressure drum 126a, in this order from the upstream side in terms of the direction of rotation of the pressure drum 126a (the counter-clockwise direction in FIG. 1).

The paper preheating unit 128 and the permeation suppression agent drying unit 132 are provided with hot air driers which can control the temperature and air blowing volume within a prescribed range. When the recording medium 114 held on the pressure drum 126a passes the positions opposing the paper preheating unit 128 and the permeation suppression agent drying unit 132, hot air heated by the hot air driers is blown toward the surface of the recording medium 114.

The permeation suppression agent ejection head 130 ejects liquid containing a permeation suppression agent (the liquid also referred to simply as “permeation suppression agent”) onto the recording medium 114 held on the pressure drum 126a. In the present embodiment, an ejection system is used as the device for depositing the permeation suppression agent on the surface of the recording medium 114, but the system is not limited to this, and it is also possible to use various other methods, such as a roller application system, a spray system, and the like.

The permeation suppression agent suppresses permeation of solvent (and organic solvent having affinity for the solvent) contained in the later-described treatment liquid and ink liquid into the recording medium 114. The permeation suppression agent is composed of resin particles dispersed as an emulsion in a solvent, or a resin dissolved in the solvent. Organic solvent or water is used as the solvent of the permeation suppression agent. Methyl ethyl ketone, petroleum, or the like may be desirably used as appropriate as the organic solvent of the permeation suppression agent.

The paper preheating unit 128 makes the temperature T₁ of the recording medium 114 higher than the lowest film formation temperature T_{f1} of the resin particles of the permeation suppression agent. Adjustment of the temperature T₁ may be carried out by the method of providing a heating element such as a heater or the like within the pressure drum 126a to heat the recording medium 114 from the bottom surface thereof, or the method of applying hot air to the upper surface of the recording medium 114, and the heating using an infrared heater to heat the recording medium 114 from the upper surface is used in the present embodiment. It is possible to use a combination of these.

For the method of depositing the permeation suppression agent, droplet ejection, spray application, and application with a roller, and the like, can be suitably used. Such droplet ejection method can be suitably used because the permeation suppression agent can be deposited selectively only on portions where ink liquid is to be ejected and the neighboring portions, which are described below. If the recording medium 114 does not easily curl, the deposition of the permeation suppression agent may be omitted.

The treatment liquid deposition unit 106 is provided after the permeation suppression agent deposition unit 104. A transfer drum 124b is provided between the pressure drum (permeation suppression agent drum) 126a of the permeation suppression agent deposition unit 104 and a pressure drum (treatment liquid drum) 126b of the treatment liquid deposition unit 106, so as to make contact with same. By adopting this structure, after the recording medium 114 which is held on the pressure drum 126a of the permeation suppression agent deposition unit 104 has been subjected to the deposition of the permeation suppression agent, the recording medium 114 is transferred through the transfer drum 124b to the pressure drum 126b of the treatment liquid deposition unit 106.

### Treatment Liquid Deposition Unit

In the treatment liquid deposition unit 106, a paper preheating unit 134, a treatment liquid ejection head 136 and a treatment liquid drying unit 138 are provided respectively at positions opposing the surface of the pressure drum 126b, in this order from the upstream side in terms of the direction of rotation of the pressure drum 126b (the counter-clockwise direction in FIG. 1).

The paper preheating unit 134 uses a similar composition to the paper preheating unit 128 of the permeation suppression agent deposition unit 104, and the explanation is omitted here. Of course, it is also possible to employ a different composition.

The treatment liquid ejection head 136 ejects the treatment liquid to the recording medium 114 held on the pressure drum 126b, and has a composition similar to ink ejection heads 140C, 140M, 140Y and 140K of the later described ink ejection unit 108. The treatment liquid used in the present embodiment is an acidic liquid that has the action of aggregating the coloring materials contained in the inks that are ejected onto the recording medium 114 respectively from the ink ejection heads 140C, 140M, 140Y and 140K disposed in the ink ejection unit 108, which is arranged at a downstream stage.

The treatment liquid drying unit 138 is provided with a hot air drier which can control the temperature and air blowing volume within a prescribed range. When the recording medium 114 held on the pressure drum 126b passes the position opposing the hot air drier of the treatment liquid drying unit 138, hot air heated by the hot air driers is blown toward the treatment liquid on the recording medium 114.

The heating temperature of the hot air drier is set to a temperature at which the treatment liquid which has been deposited on the recording medium 114 by the treatment liquid ejection head 136 disposed to the upstream side in terms of the direction of rotation of the pressure drum 126b is dried, and a solid or semi-solid aggregating treatment agent layer (a thin film layer of dried treatment liquid) is formed on the recording medium 114.

Reference here to “aggregating treatment agent layer in a solid state or a semi-solid state” includes a layer having a moisture content ratio of 0% to 70% as defined below.

“Moisture content ratio”=

“Weight per unit surface area of water contained in treatment liquid after drying (g/m²)”/“Weight per unit surface area of treatment liquid after drying (g/m²)” Formula 1

Also, “aggregating treatment agent” refers not only to a solid or semi-solid substance, but in addition is used in the broader concept to include a liquid substance. In particular, liquid aggregating treatment agent that includes 70% or more solvent (content rate of solvent) is referred to as “aggregating treatment liquid”.

The method of calculating the solvent content of the aggregating treatment agent is to cut out a specific size of sheet (for example 100 mm×100 mm), and to measure the total weight after applying treatment liquid (sheet+treatment liquid before drying) and the total weight after drying the treatment liquid (sheet+treatment liquid after drying). From the difference of these measurements, the amount of reduction in solvent due to drying (quantity of solvent evaporated) is obtained. Also, the calculated quantity obtained from the method of adjusting the treatment liquid may be used as the quantity of solvent contained in the treatment liquid before drying. From these calculation results, the solvent content can be obtained.

Here, the following Table 1 illustrates the results of evaluation of the movement of color material when the solvent content rate of the treatment liquid (aggregation treatment agent layer) on the recording medium 114 is changed.

TABLE 1

| | Experiment 1 | Experiment 2 | Experiment 3 | Experiment 4 | Experiment 5 |
|---|---|---|---|---|---|
| Drying process | Not Exist | Exist | Exist | Exist | Exist |
| Total weight (g/m²) | 10.0 | 6.0 | 4.0 | 3.0 | 1.3 |
| Weight of water | 8.7 | 4.7 | 2.7 | 1.5 | 0 |
| (g/m²) | | | | | |
| Content rate of | 87 | 78 | 67 | 50 | 0 |
| solvent (%) | | | | | |
| Movement of | Poor | Average | Good | Excellent | Excellent |
| coloring material | (Failure) | (Dot moved | (Inconspicuous | | |
| | | slightly) | though | | |
| | | | dot moved) | | |

As illustrated in Table 1, if the treatment liquid was not dried (Experiment 1), image degradation due to movement of color material occurred.

In contrast, in cases where the treatment liquid was dried (Experiments 2 to 5), when the treatment liquid was dried until the solvent content in the treatment liquid became 70% or less, movement of color material was not conspicuous. Further, when the treatment liquid was dried until the solvent content in the treatment liquid became 50% or less, the level was so good that movement of color material could not be detected visually. Therefore it has been confirmed that this is effective in preventing image degradation.

In this way, by drying the treatment liquid on the recording medium 114 to a solvent content of 70% or less (desirably 50% or less) so that a solid or semi-solid layer of aggregation treatment agent is formed on the recording medium 114, it is possible to prevent image degradation due to movement of color material.

A desirable mode is one in which the recording medium 114 is preheated by the heater of the paper preheating unit 134, before depositing treatment liquid on the recording medium 114, as in the present embodiment. In this case, it is possible to restrict the heating energy required to dry the treatment liquid to a low level, and therefore energy savings can be made.

### Ink Ejection Unit

The ink ejection unit 108 is provided after the treatment liquid deposition unit 106. A transfer drum 124c is provided between the pressure drum (treatment liquid drum) 126b of the treatment liquid deposition unit 106 and a pressure drum 126c of the ink ejection unit 108, so as to make contact with same. By means of this structure, the treatment liquid is deposited onto the recording medium 114 held on the pressure drum 126b of the treatment liquid deposition unit 106, thereby forming a solid or semi-solid layer of aggregating treatment agent, whereupon the recording medium 114 is transferred through the transfer drum 124c to the pressure drum 126c of the ink ejection unit 108.

In the ink ejection unit 108, the ink ejection heads 140C, 140M, 140Y and 140K which correspond respectively to four colors of ink, C (cyan), M (magenta), Y (yellow) and K (black), and solvent drying units 142a and 142b are provided respectively at positions opposing the surface of the pressure drum 126c, in this order from the upstream side in terms of the direction of rotation of the pressure drum 126c (the counter-clockwise direction in FIG. 1).

The ink ejection heads 140C, 140M, 140Y and 140K employ liquid ejection type recording heads (liquid ejection heads), similarly to the above-described treatment liquid ejection head 136. In other words, the ink ejection heads 140C, 140M, 140Y and 140K respectively eject droplets of corresponding colored inks onto the recording medium 114 held on the pressure drum 126c.

An ink storing and loading unit (not illustrated) has ink tanks for storing the inks to be supplied to the ink ejection heads 140C, 140M, 140Y and 140K, respectively. The tanks are connected to the corresponding ink ejection heads by means of prescribed channels, and supply the inks to the corresponding ink ejection heads. The ink storing and loading unit has a warning device (for example, a display device or an alarm sound generator) for warning when the remaining amount of any ink in the tank is low, and has a mechanism for preventing loading errors among the colors.

The inks are supplied from the ink tanks of the ink storing and loading unit to the ink ejection heads 140C, 140M, 140Y and 140K, and droplets of the colored inks are ejected from the ink ejection heads 140C, 140M, 140Y and 140K in accordance with the image signal toward the recording medium 114.

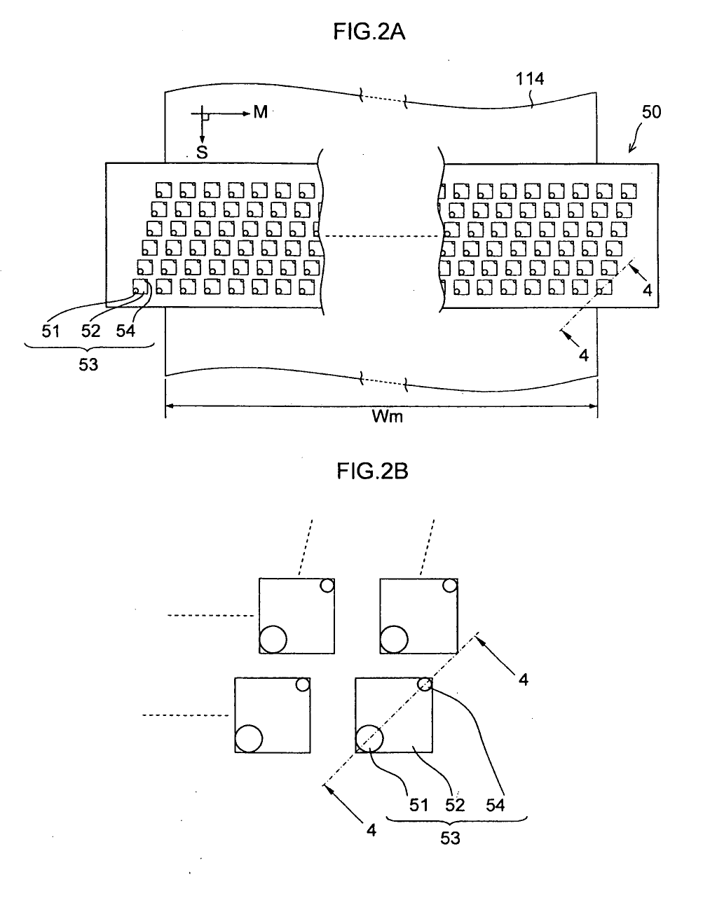

Each of the ink ejection heads 140C, 140M, 140Y and 140K is the full-line type head (see FIG. 2A) which has a length corresponding to a maximum width of an image forming region of the recording medium 114 held on the pressure drum 126c, and has the plurality of nozzles for ejecting ink (not illustrated in FIG. 1) arrayed on the ink ejection surface thereof over the full width of the image forming region of the recording medium 114. The ink ejection heads 140C, 140M, 140Y and 140K are fixed so as to extend in a direction that is perpendicular to the direction of rotation of the pressure drum 126c (the conveyance direction of the recording medium 114). According to the composition in which such full line heads having the nozzle rows which cover the full width of the image forming region of the recording medium 114 are provided for the respective colors of ink, it is possible to record an image on the image forming region of the recording medium 114 by performing just one operation of moving the recording medium 114 and the ink ejection heads 140C, 140M, 140Y and 140K relatively to each other (in other words, by one sub-scanning action) in the conveyance direction (the sub-scanning direction) by conveying the recording medium 114 in a fixed speed by the pressure drum 126c. This single-pass type image formation with such a full line type (page-wide) head can achieve a higher printing speed compared to a case of a multi-pass type image formation with a serial (shuttle) type of head which moves back and forth reciprocally in the direction (the main scanning direction) perpendicular to the conveyance direction of the recording medium (sub-scanning direction), and hence it is possible to improve the print productivity.

The inkjet recording apparatus 100 according to the present embodiment is able to record on recording media (recording paper) up to a maximum size of 720 mm×520 mm and hence a drum having a diameter of 810 mm corresponding to the recording medium width of 720 mm is used for the pressure drum (print drum) 126c. The ink ejection volume of the ink ejection heads 140C, 140M, 140Y and 140K is 2 pl, for example, and the recording density is 1200 dpi in both the main scanning direction (the widthwise direction of the recording medium 114) and the sub-scanning direction (the conveyance direction of the recording medium 114). Although the configuration with the CMYK four colors is described in the present embodiment, combinations of the ink colors and the number of colors are not limited to those. Light inks, dark inks or special color inks can be added or removed as required. For example, a configuration in which ink heads for ejecting light-colored inks such as light cyan and light magenta are added, or a configuration using the CMYK four colors is possible. Furthermore, there are no particular restrictions of the sequence in which the heads of respective colors are arranged.

Each of the solvent drying units 142a and 142b has a composition including a hot air drier which can control the temperature and air blowing volume within a prescribed range, similarly to the paper preheating units 128 and 134, the permeation suppression agent drying unit 132, and the treatment liquid drying unit 138, which are described above. If ink droplets are ejected onto the layer of aggregating treatment agent in a solid state or semi-solid state which has been formed on the recording medium 114, an ink aggregate (coloring material aggregate) is formed on the recording medium 114, and furthermore, the ink solvent which has separated from the coloring material spreads and a liquid layer of dissolved aggregating treatment agent is formed. The solvent component (liquid component) left on the recording medium 114 in this way is a cause of curling of the recording medium 114 and also leads to deterioration of the image. Therefore, in the present embodiment, after ejecting droplets of the corresponding colored inks onto the recording medium 114 respectively from the ink ejection heads 140C, 140M, 140Y and 140K, the solvent component is evaporated off and dried by the hot air driers of the solvent drying units 142a and 142b.

The fixing unit 110 is provided subsequent to the ink ejection unit 108, and a transfer drum 124d is provided between the pressure drum (image rendering drum) 126c of the ink ejection unit 108 and a pressure drum (fixing drum) 126d of the fixing unit 110 so as to make contact with the pressure drums. By this means, after the respective colored inks have been deposited on the recording medium 114 which is held on the pressure drum 126c of the ink ejection unit 108, the recording medium 114 is transferred through the transfer drum 124d to the pressure drum 126d of the fixing unit 110.

### Fixing Unit

The fixing unit 110 is provided with an inline determination unit 144, which reads in the print results of the ink ejection unit 108, and heating rollers 148a and 148b at positions opposing the surface of the pressure drum 126d, in this order from the upstream side in terms of the direction of rotation of the pressure drum 126d (the counter-clockwise direction in FIG. 1). The inline determination unit 144 serves as a device reading the output images, includes an image sensor (a line sensor, or the like) which captures an image of the print result of the ink ejection unit 108 (the ink droplet deposition results of the ink ejection heads 140C, 140M, 140Y and 140K), and functions as a device for checking for nozzle blockages and other ejection defects and as a device for color measurement (colorimetry), on the basis of the droplet ejection image captured through the image sensor.

In this embodiment, a test pattern such as a color patch and line pattern is formed in the image recording area or non-image portion of the recording medium 114, this test pattern is read in by an in-line determination unit 144, and in-line determination is carried out, for instance, to acquire color information (colorimetry), determine density non-uniformities, judge the presence or absence of ejection abnormalities in the respective nozzles, and the like, on the basis of the reading results.

Each of the heating rollers 148a and 148b is a roller of which temperature can be controlled in a prescribed range (e.g., 100° C. to 180° C.). The image formed on the recording medium 114 is fixed while nipping the recording medium 114 between the heating roller 148a or 148b and the pressure drum 126d to heat and press the recording medium 114. It is desirable that the heating temperature of the heating rollers 148a and 148b is set in accordance with the glass transition temperature of the polymer particles contained in the treatment liquid or the ink, for example.

The paper output unit 112 is arranged after the fixing unit 110. The paper output unit 112 is provided with a paper output drum 150, which receives the recording medium 114 on which the image has been fixed, a paper output platform 152, on which the recording media 114 are stacked, and a paper output chain 154 having a plurality of paper output grippers, which is spanned between a sprocket arranged on the paper output drum 150 and a sprocket arranged above the paper output platform 152.

### Structure of Head

Next, the structure of heads 130, 136, 140C, 140M, 140Y and 140 K will be described. The heads 12K, 12C, 12M and 12Y of the respective ink colors have the same structure, and a reference numeral 50 is hereinafter designated to any of the heads.

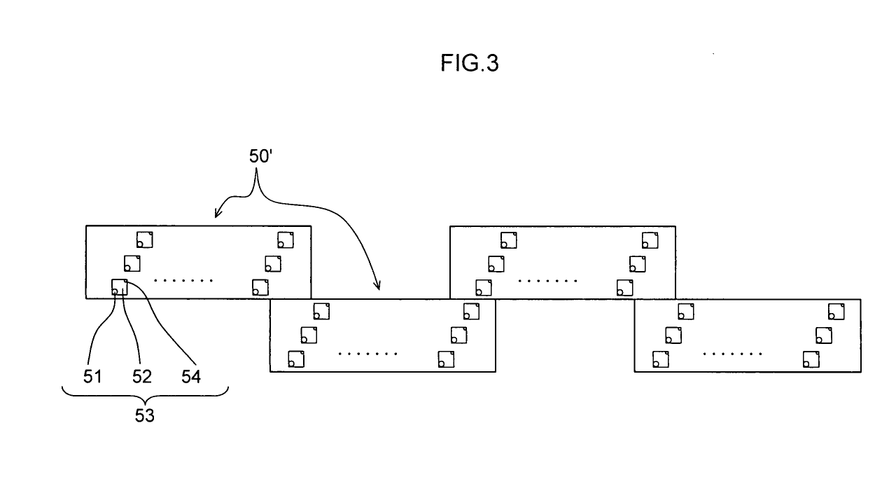

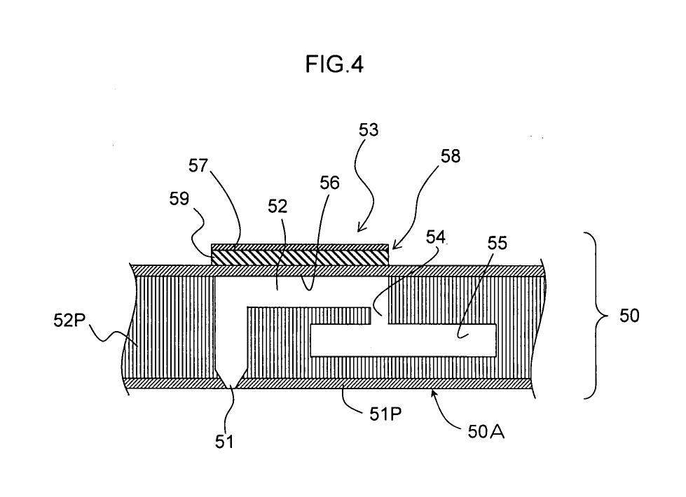

FIG. 2A is a plan perspective diagram illustrating an example of the structure of a head 50, and FIG. 2B is a partial enlarged diagram of same. Moreover, FIG. 3 is a planar perspective view illustrating another structural example of the head 50, and FIG. 4 is a cross-sectional diagram illustrating a liquid droplet ejection element for one channel being a recording element unit (an ink chamber unit corresponding to one nozzle 51) (a cross-sectional diagram along line 4-4 in FIGS. 2A and 2B).

The nozzle pitch in the head 50 should be minimized in order to maximize the density of the dots printed on the surface of the recording medium 114. As illustrated in FIGS. 2A and 2B, the head 50 according to the present embodiment has a structure in which a plurality of ink chamber units 53 (liquid droplet ejection elements), each comprising a nozzle 51 forming an ink droplet ejection hole, a pressure chamber 52 corresponding to the nozzle 51, and the like, are disposed two-dimensionally in the form of a staggered matrix, and hence the effective nozzle interval (the projected nozzle pitch) as projected (orthographically-projected) in the lengthwise direction of the head (the direction perpendicular to the paper conveyance direction) is reduced and high nozzle density is achieved.

The mode of forming nozzle rows which have a length equal to or more than the entire width Wm of the recording medium 114 in a direction (direction indicated by arrow M: main scanning direction) substantially perpendicular to the paper conveyance direction (direction indicated by arrow S: sub-scanning direction) of the recording medium 114 is not limited to the example described above. For example, instead of the configuration in FIG. 2A, as illustrated in FIG. 3, a line head having nozzle rows of a length corresponding to the entire width of the recording medium 114 can be formed by arranging and combining, in a staggered matrix, short head modules 50′ having a plurality of nozzles 51 arrayed in a two-dimensional fashion. Furthermore, although not illustrated in the drawings, it is also possible to compose a line head by arranging short heads in one row.

As illustrated in FIG. 2, a pressure chamber 52 provided to each nozzle 51 has substantially a square planar shape (see FIGS. 2A and 2B), and has an outlet port for the nozzle 51 at one of diagonally opposite corners and an inlet port (supply port) 54 for receiving the supply of the ink at the other of the corners. The planar shape of the pressure chamber 52 is not limited to this embodiment and can be various shapes including quadrangle (rhombus, rectangle, etc.), pentagon, hexagon, other polygons, circle, and ellipse.

As illustrated in FIG. 4, the head 50 is configured by stacking and joining together a nozzle plate 51P, a flow channel plate 52P, a diaphragm 56, and the like. The nozzle plate 51P constitutes a nozzle surface (ink ejection surface) 50a of the head 50 and has formed therein the two-dimensionally arranged nozzles 51 communicating respectively to the pressure chambers 52.

The flow channel plate 52P constitutes side wall parts of the pressure chamber 52 and serves as a flow channel formation member, which forms the supply port 54 as an aperture part (the narrowest part) of the individual supply channel leading the ink from the common flow channel 55 to the pressure chamber 52. FIG. 4 is simplified for the convenience of explanation, and the flow channel plate 52P may be structured by stacking one or more substrates.

The diaphragm 56 constituting one wall face (upper face in FIG. 4) of the pressure chamber 52 is made of an electrically-conductive material, such as stainless steel (SUS), or silicon (Si) with a nickel (Ni) conductive layer. The diaphragm 56 also serves as a common electrode of a plurality of actuators (piezoelectric elements) 58, which are disposed on the respective pressure chambers 52. The diaphragm can be formed by a non-conductive material such as resin; and in this case, a common electrode layer made of a conductive material such as metal is formed on the surface of the diaphragm member.

A piezoelectric body 59 is arranged on a surface (upper side in FIG. 4) of the diaphragm 56 that is on the opposite side from the pressure chamber 52, so as to be in a position corresponding to the pressure chamber 52, and an individual electrode 57 is formed on an upper surface of the piezoelectric body 59 (surface on the other side of the surface contacting the diaphragm 56 serving as the common electrode). This individual electrode 57, the common electrode (served by the diaphragm 56 in this embodiment) opposing the individual electrode 57, and the piezoelectric body 59 interposed between these electrodes configure the piezoelectric element functioning as each actuator 58. Lead zirconate titanate, barium titanate, or other piezoelectric material is favorably used as the piezoelectric body 59.

Each pressure chamber 52 is connected via a supply port 54 to a common flow channel 55. The common flow channel 55 is connected to an ink tank (not illustrated), which is a base tank that supplies ink, and the ink supplied from the ink tank is delivered through the common flow channel 55 to each of the pressure chambers 52.

When a drive voltage is applied between the individual electrode 57 of the actuator 58 and the common electrode, the actuator 58 is deformed, the volume of the pressure chamber 52 is thereby changed, and the pressure in the pressure chamber 52 is thereby changed, so that the ink inside the pressure chamber 52 is ejected through the nozzle 51. When the displacement of the actuator 58 is returned to its original state after the ink is ejected, new ink is refilled in the pressure chamber 52 from the common flow channel 55 through the supply port 54.

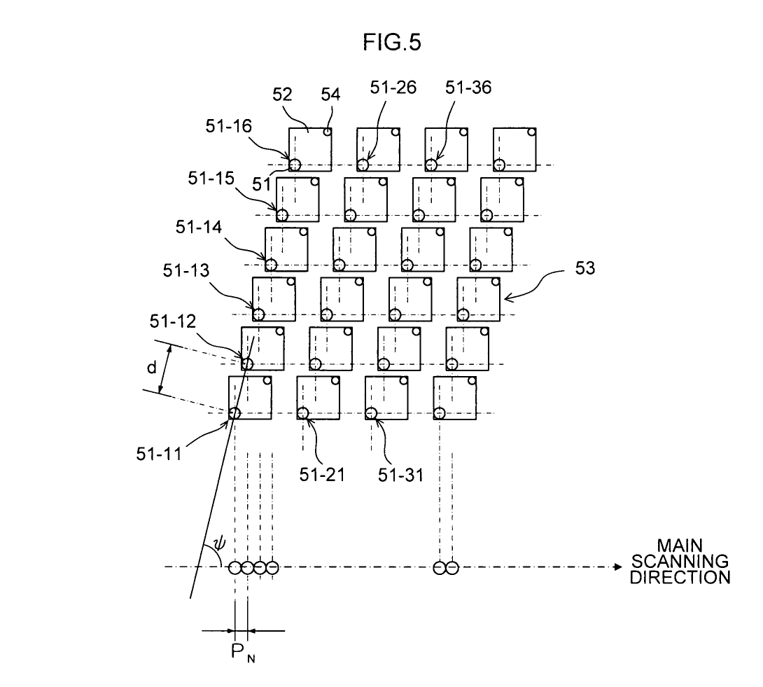

As illustrated in FIG. 5, the high-density nozzle head according to the present embodiment is achieved by arranging a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of ψ with respect to the main scanning direction, the pitch PN of the nozzles projected so as to align in the main scanning direction is d×cos ψ, and hence the nozzles 51 can be regarded to be equivalent to those arranged linearly at a fixed pitch PN along the main scanning direction. This structure can achieve a high density nozzle structure in which a nozzle row obtained by projecting the nozzles so as to align in the main scanning direction includes 1200 nozzles/inch for example.

In a full-line head comprising rows of nozzles that have a length corresponding to the entire width of the image recordable width, the “main scanning” is defined as printing one line (a line formed of a row of dots, or a line formed of a plurality of rows of dots) in the width direction of the recording medium (the direction perpendicular to the conveyance direction of the recording medium) by driving the nozzles in one of the following ways: (1) simultaneously driving all the nozzles; (2) sequentially driving the nozzles from one side toward the other; and (3) dividing the nozzles into blocks and sequentially driving the nozzles from one side toward the other in each of the blocks.

In particular, when the nozzles 51 arranged in a matrix such as that illustrated in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block; . . . ); and one line is printed in the width direction of the recording medium 114 by sequentially driving the nozzles 51-11, 51-12, . . . , 51-16 in accordance with the conveyance velocity of the recording medium 114.

On the other hand, “sub-scanning” is defined as to repeatedly perform printing of one line (a line formed of a row of dots, or a line formed of a plurality of rows of dots) formed by the main scanning, while moving the full-line head and the recording medium relatively to each other.

The direction indicated by one line (or the lengthwise direction of the band-shaped region thus recorded) recorded by the main scanning action is called the “main scanning direction”, and the direction in which sub-scanning is performed is called the sub-scanning direction. Consequently, the conveyance direction of the recording medium 114 is the sub-scanning direction and the direction perpendicular to the sub-scanning direction is called the main scanning direction.

The arrangement of the nozzles of embodiments of the present invention is not limited to the arrangements illustrated in the drawings. The present embodiment adopts a method in which an ink droplet is ejected by deforming an actuator represented by a piezoelectric element, but the method for ejecting ink is not limited in particular. Instead of such a piezo jet method, various methods can be adopted, such as a thermal jet method in which an ink droplet is ejected by a pressure caused by an air bubble generated by heating the ink with a heat generation body such as a heater.

### Structure of Liquid Supply System

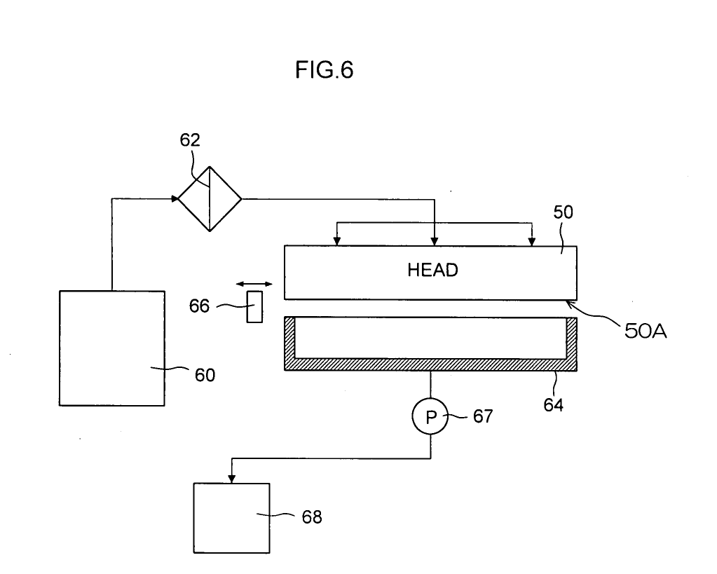

FIG. 6 is a schematic drawing illustrating the configuration of the ink supply system in the inkjet recording apparatus 100. Although an ink supply system is explained here, the same supply system or a similar supply system may be provided for ejecting a treatment liquid.

The ink tank 60 is a base tank to supply ink to the head 50. The aspects of the ink tank 60 include a refillable type and a cartridge type: when the remaining amount of ink is low, the ink tank of the refillable type is filled with ink through a filling port (not illustrated) and the ink tank of the cartridge type is replaced with a new one. In order to change the ink type in accordance with the intended application, the cartridge type is suitable, and it is desirable to represent the ink type information with a bar code or the like, and to perform ejection control in accordance with the ink type.

A filter 62 for removing foreign matters and bubbles is disposed in the middle of the channel connecting the ink tank 60 and the head 50 as illustrated in FIG. 6. The filter mesh size in the filter 62 is desirably equivalent to or not more than the diameter of the nozzle of print head. Although not illustrated in FIG. 6, it is desirable to provide a sub-tank integrally to the head 50 or nearby the head 50. The sub-tank has a damper function for preventing variation in the internal pressure of the head and a function for improving refilling of the print head.

The inkjet recording apparatus 100 is also provided with a cap 64 as a device to prevent the nozzles 51 from drying out or to prevent an increase in the ink viscosity in the vicinity of the nozzles, and a cleaning wiper 66 as a device to clean the nozzle surface 50A. A maintenance unit (restoring unit) including the cap 64 and the cleaning wiper 66 can be relatively moved with respect to the head 50 by a movement mechanism (not illustrated), and is moved from a place for restoration to a place for maintenance below the head 50 as required.

The cap 64 is displaced up and down relatively with respect to the head 50 by an elevator mechanism (not illustrated). When the power of the inkjet recording apparatus is turned OFF or when the apparatus 100 is in a standby state for printing, the elevator mechanism raises the cap 64 to a predetermined elevated position so as to come into close contact with the head 50, and the nozzle region of the nozzle surface 50A is thereby covered by the cap 64.

The cleaning wiper 66 is composed of rubber or another elastic member, and can slide on the nozzle surface 50A (nozzle plate surface) of the head 50 by means of a wiper movement mechanism (not illustrated). When ink droplets or foreign matter has adhered to the nozzle plate surface, the nozzle surface is wiped and cleaned by sliding the cleaning wiper 66 on the nozzle plate.

During printing or standby, a preliminary discharge (dummy ejection operation) is made to eject the degraded ink toward the cap 64 (which also serves as an ink receptacle) in order to discharge ink in nozzles, when the ink viscosity is increased for a particular nozzle due to decline of use frequency of the particular nozzle.

If the head 50 continues in a state in which ink is not ejected from the head 50 for a certain amount of time or longer, the ink solvent in the vicinity of the nozzles 51 evaporates and the ink viscosity increases. In such a state, ink can no longer be ejected from the nozzles 51 even if the actuators 58 for driving ejection are operated. Therefore, before a state of this kind is reached (while the ink is in a range of viscosity which allows ink to be ejected by means of operation of the actuators 58), a “preliminary ejection” is carried out, whereby the actuators 58 are operated and the ink in the vicinity of the nozzles, which is of raised viscosity, is ejected toward the ink receptacle.

After the nozzle surface is cleaned by a wiper such as the cleaning wiper 66 provided as the cleaning device for the nozzle face 50A, a preliminary discharge is also carried out in order to prevent the foreign matter from becoming mixed inside the nozzles 51 by the wiper sliding operation.

On the other hand, if air bubbles become intermixed into a nozzle 51 or a pressure chamber 52, or if the rise in the viscosity of the ink inside a nozzle 51 exceeds a certain level, then it may not be possible to eject ink in the preliminary ejection operation described above. In cases of this kind, the cap 64 forming a suction device is pressed against the nozzle surface 50A of the print head 50, and the ink inside the pressure chambers 52 (namely, the ink containing air bubbles of the ink of increased viscosity) is suctioned by a suction pump 67. The ink suctioned and removed by means of this suction operation is sent to a recovery tank 68. The ink collected in the recovery tank 68 may be used, or if reuse is not possible, it may be discarded. Since the suctioning operation is performed with respect to all of the ink in the pressure chambers 52, it consumes a large amount of ink, and therefore, desirably, restoration by preliminary ejection is carried out while the increase in the viscosity of the ink is still minor. The suction operation is also carried out when ink is loaded into the print head 50 for the first time, and when the head starts to be used after being idle for a long period of time. The maintenance of the head 50 such as the preliminary ejection and suction operation is carried out, in a state where the head 50 is moved from the image forming position (printing position) immediately above the pressure drum 126c (also called “drum”) and placed in a predetermined maintenance position (for example, a position outside the pressure drum 126c in terms of the axial direction of the pressure drum 126c).

### Description of Control System

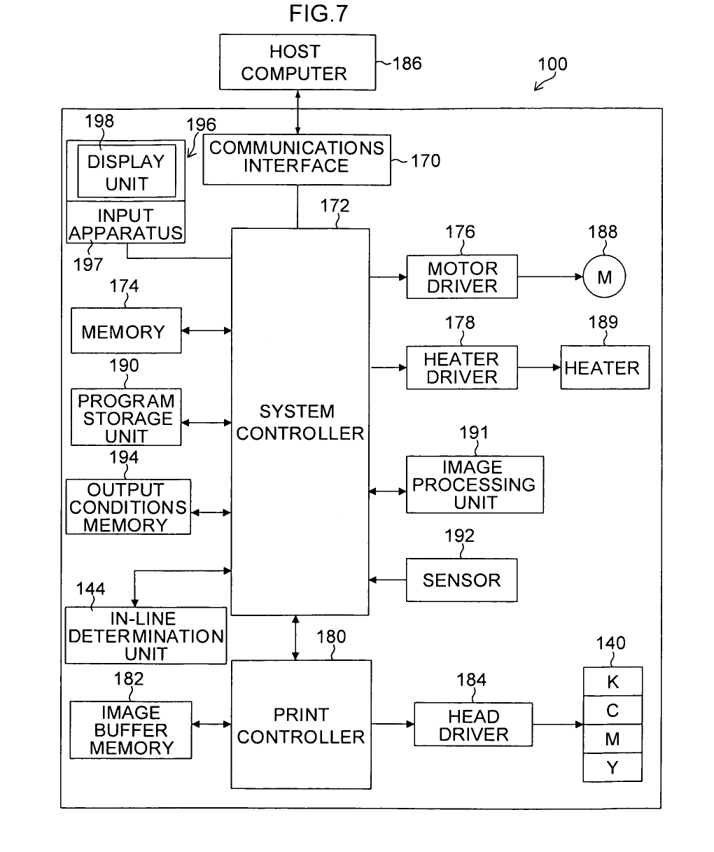

FIG. 7 is a principal block diagram illustrating the system configuration of the inkjet recording apparatus 100. The inkjet recording apparatus 100 includes a communications interface 170, a system controller 172, a memory 174, a motor driver 176, a heater driver 178, a print controller 180, an image buffer memory 182, a head driver 184, and the like.

The communications interface 170 is an interface unit serving as an image input device for receiving image data sent from a host computer 186. A serial interface such as USB (Universal Serial Bus), IEEE1394, Ethernet, wireless network, or a parallel interface such as a Centronics interface may be used as the communications interface 170. A buffer memory (not illustrated) may be mounted in this portion in order to increase the communication speed. The image data sent from the host computer 186 is received by the inkjet recording apparatus 100 through the communications interface 170, and is temporarily stored in the memory 174.

The memory 174 is a storage device for temporarily storing image data inputted through the communications interface 170, and data is written and read to and from the memory 174 through the system controller 172. The memory 174 is not limited to a memory composed of semiconductor elements, and a hard disk drive or another magnetic medium may be used.

The system controller 172 is constituted of a central processing unit (CPU) and peripheral circuits thereof, and the like, and it functions as a control device for controlling the whole of the inkjet recording apparatus 100 in accordance with a prescribed program, as well as a calculation device for performing various calculations. More specifically, the system controller 172 controls the various sections, such as the communications interface 170, memory 174, motor driver 176, heater driver 178, and the like, as well as controlling communications with the host computer 186 and writing and reading to and from the memory 174, and it also generates control signals for controlling the motor 188 and heater 189 of the conveyance system.

The program executed by the CPU of the system controller 172 and the various types of data which are required for control procedures are stored in the memory 174. The memory 174 may be a non-rewriteable storage device, or it may be a rewriteable storage device, such as an EEPROM. The memory 174 is used as a temporary storage region for the image data, and it is also used as a program development region and a calculation work region for the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk such as hard disk drive, or the like. An external interface may be provided, and a memory card or PC card may also be used. Naturally, a plurality of these recording media may also be provided. The program storage unit 190 may also be combined with a storage device for storing operational parameters, and the like (not illustrated).

The motor driver 176 is a driver that drives the motor 188 in accordance with instructions from the system controller 172. In FIG. 7, the plurality of motors (actuators) disposed in the respective sections of the inkjet recording apparatus 100 are represented by the reference numeral 188. For example, the motor 188 illustrated in FIG. 7 includes the motors that drive the pressure drums 126a to 126d, the transfer drums 124a to 124d and the paper output drum 150, illustrated in FIG. 1.

The heater driver 178 is a driver that drives the heater 189 in accordance with instructions from the system controller 172. In FIG. 7, the plurality of heaters disposed in the inkjet recording apparatus 100 are represented by the reference numeral 189. For example, the heater 189 illustrated in FIG. 7 includes the heaters of the paper preheating units 128 and 134, the permeation suppression agent drying unit 132, the treatment liquid drying unit 138, the solvent drying unit 142a and 142b, the heating rollers 148a and 148b, illustrated in FIG. 1.

The print controller 180 is a control unit that has signal processing functions for carrying out processing, correction, and other treatments in order to generate a print control signal on the basis of the image data in the memory 174 in accordance with the control of the system controller 172. The print controller 180 supplies the print data (dot data) thus generated to the head driver 184. Prescribed signal processing is carried out in the print controller 180, and the ejection volume and the ejection timing of the ink droplets in the head 140 (representing the ink ejection heads 140C, 140M, 140Y and 140K illustrated in FIG. 1) are controlled through the head driver 184 on the basis of the image data. By this means, desired dot size and dot positions can be achieved.

The print controller 180 is provided with the image buffer memory 182, and image data, parameters, and other data are temporarily stored in the image buffer memory 182 when image data is processed in the print controller 180. Also possible is an aspect in which the print controller 180 and the system controller 172 are integrated to form a single processor.

To give a general description of the sequence of processing from image input to print output, image data to be printed is inputted from an external source through the communications interface 170, and is accumulated in the image memory 174. The original image data (RGB data) stored in the image memory 174 is sent to the print controller 180 through the system controller 172, and is converted to the dot data (binary data or multiple-value data including the information of the dot size) for each ink color (K, C, M, Y) by a half-toning technique, using dithering, error diffusion, or the like, in the print controller 180.

The dot data thus generated by the print controller 180 is stored in the image buffer memory 182. This dot data of the respective colors is converted into CMYK droplet ejection data for ejecting ink from the nozzles of the head 140, thereby establishing the ink ejection data to be printed.

The head driver 184 outputs drive signals for driving the piezoelectric elements (the actuator 58 in FIG. 4) corresponding to the nozzles 51 of the head 140, on the basis the print data supplied by the print controller 180 (i.e., the dot data stored in the image buffer memory 182). A feedback control system for maintaining constant drive conditions in the head may be included in the head driver 184.

The inkjet recording apparatus 100 uses the piezoelectric driving system in which the common driving waveform signal is applied to the piezoelectric elements corresponding to the nozzles, to change the on and off of the switching elements connected to the individual electrodes of the piezoelectric elements in accordance with the ejection timings of the piezoelectric elements (the actuators 38) so that droplets of the ink are ejected from the nozzles corresponding to the piezoelectric elements.

The in-line determination unit 144 is a block that includes the CCD line sensor as described above with reference to FIG. 1, reads the image printed on the recording medium 114, determines the print conditions (color, concentration, presence of the ejection, variation in the droplet deposition, and the like) by performing required signal processing, or the like, and provides the determination results of the print conditions to the print controller 180 through the system controller 172.

The system controller 172, in conjunction with the image processing unit 191, carries out colorimetry calculation, calculation of color correction values and correction processing, on the basis of information obtained from the in-line determination unit 144. The image processing unit 191 for processing the read image can also be constituted by hardware, such as an ASIC, or constituted by software, or realized by a combination of these. Furthermore, if an ejection abnormality, such as an ejection failure nozzle or a landing position displacement, is determined by reading in a line pattern of all of the nozzles or reading in a density pattern of all of the nozzles, for instance, the print controller 180 judges the positions of the ejection abnormality nozzles and the abnormality status of same (ejection failure, landing position displacement, ejection volume abnormality, or the like) on the basis of the information obtained from the in-line determination unit 144, in addition to which, if correction of the ejection abnormality nozzles is possible by image correction, the print controller sends control signals to the respective units via the system controller 172. On the other hand, if it is not possible to achieve correction by means of image correction, then the print controller 180 sends control signals to the respective units via the system controller 172 in such a manner that a nozzle restoration operation, such as preliminary ejection or suction, is carried out in respect of the ejection abnormality nozzles.

The sensor 192 in FIG. 7 represents sensors of various kinds provided in the respective units of the apparatus. The sensor 192 includes a temperature sensor, humidity sensor, paper position determination sensor, pressure sensor, and the like. The output signals of the sensor 192 are sent to the system controller 172, and the system controller 172 sends control signals to the respective units of the apparatus on the basis of these output signals, whereby the respective units of the apparatus are controlled.

The inkjet recording apparatus 100 according to the present embodiment comprises an output conditions memory 194 which stores the output conditions of printed items which have been printed in the past, and the history of changes in conditions, and the like. The “output conditions” include ambient conditions, such as temperature.

The output conditions memory 194 is constituted by a rewriteable non-volatile storage device, but it is also possible to use (share) the storage area of the program storage unit 190.

The operating unit 196 which forms a user interface is constituted by an input apparatus 197 where the operator can make various inputs and a display unit (display) 198. The input apparatus 197 may employ various formats, such as a keyboard, mouse, touch panel, buttons, or the like. By operating the input apparatus 197, an operator is able to input printing conditions, input and edit additional information, search for information in the output conditions memory 194, and so on, and is able to confirm information of various types, such input contents, search results, and the like, via the display on the display unit 198.

A combination of the system controller 172 and the print controller 180 illustrated in FIG. 7 functions as the “image output controller”, the “patch forming controller”, and the “correction data change device”, and a combination of the system controller 172 and the image processing unit 191 functions as the “colorimetry calculation processing device”. Furthermore, the output conditions memory 194 corresponds to the “memory device”, and a combination of the operating unit 196 and the system controller 172 corresponds to the “search device”.

### Example of Composition of in-Line Determination Unit

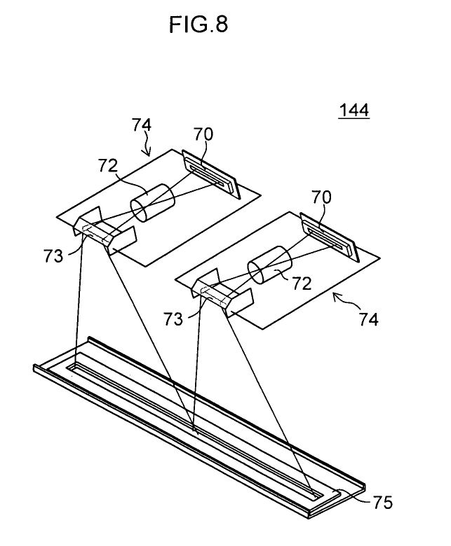

FIG. 8 is a schematic drawing of the in-line determination unit 144. In the in-line determination unit 144, reading unit sensors 74, each comprising, in a mutually integrated fashion, a line CCD 70 (corresponding to a “read device”), a lens 72 which provides an image on a light receiving surface of the line CCD 70, and a mirror 73 which bends the light path, are provided in parallel fashion and each read out the image on a recording medium. The line CCD 70 has an array of color-specific photocells (pixels) provided with three-color RGB filters, and is able to read in a color image by means of RGB color analysis (RGB color separation). For example, next to each photo cell array of 3 RGB lines, there is provided a CCD analog shift register which respectively and independently transfers the charges of the even-numbered pixels and odd-numbered pixels in one line.

More specifically, it is possible to use a line CCD “μPD8827A” (product name) having a pixel pitch of 9.325 μM, 7600 pixels×RGB, and a pixel length (width of sensor in direction of arrangement of photocells) of 70.87 mm, manufactured by NEC Electronics Corporation.

The line CCD 70 is fixed in a configuration where the direction of arrangement of the photocells is parallel with the axis of the drum on which the recording medium is conveyed.

The lens 72 is a lens of a condenser optics system which provides the image on the recording medium that is wrapped about the conveyance drum (pressure drum 126d in FIG. 1), at a prescribed rate of reduction. For example, if a lens which reduces the image to 0.19 times is employed, then the 373 mm width on the recording medium is provided onto the line CCD 70. In this case, the reading resolution on the recording medium is 518 dpi.

As illustrated in FIG. 8, the reading sensor units 74 each comprising an integrated line CCD 70, lens 72 and mirror 73 can be moved and adjusted in parallel with the axis of the conveyance drum, whereby the positions of the two reading sensor units 74 are adjusted and the respective reading sensor units 74 are disposed in such a manner that the images read by same are slightly overlapping. Furthermore, although not illustrated in FIG. 8, as an illumination device for determination, a xenon fluorescent lamp is disposed on the rear surface of a bracket 75, on the side of the recording medium, and a white reference plate is inserted periodically between the image and the illumination source so as to measure a white reference. In this state, the lamp is extinguished and a black reference level is measured.

The reading width of the line CCD 70 (the extent to which the determination (scanning) can be performed in one action) can be designed variously in accordance with the width of the image recording range on the recording medium. From the viewpoint of lens performance and resolution, for example, the reading width of the line CCD 70 is approximately ½ of the width of the image recording range (the maximum width which can be scanned).

The image data obtained by the line CCD 70 is converted into digital data by an A/D converter, or the like, and then stored in a temporary memory, whereupon the data is processed via the system controller 172 and stored in the memory 174.

Device for Improving Color Stability within Job

In the case of commercial printing, such as a product catalog or publicity leaflet, or other publication, or the like, the step of printing one picture (printed item) reaches 2000 or fewer copies, at the least, and many tens of thousands of copies, at the most. It is necessary to maintain the image quality of the printed item (color stability, density, or the like) between the start and the end of this printing step, and for example, it is required that, at the same position on the image surface, the color difference (the difference in the color specification value in a color space) is managed to within a set acceptable value (e.g. ΔE<3).

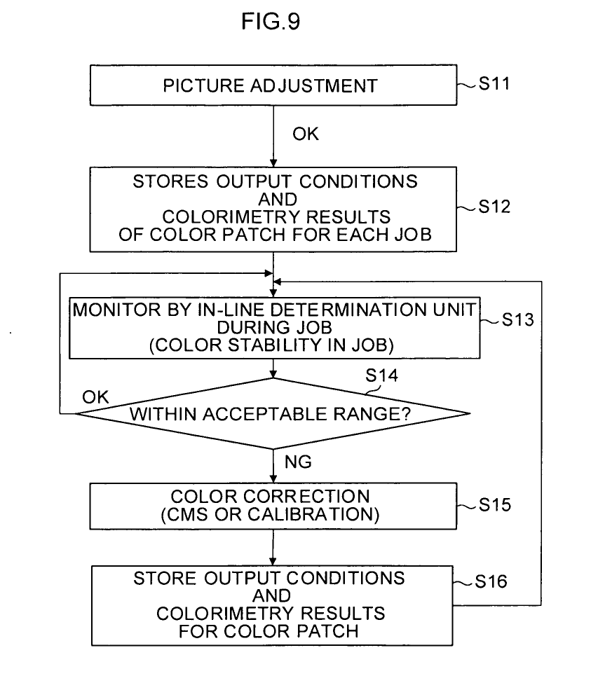

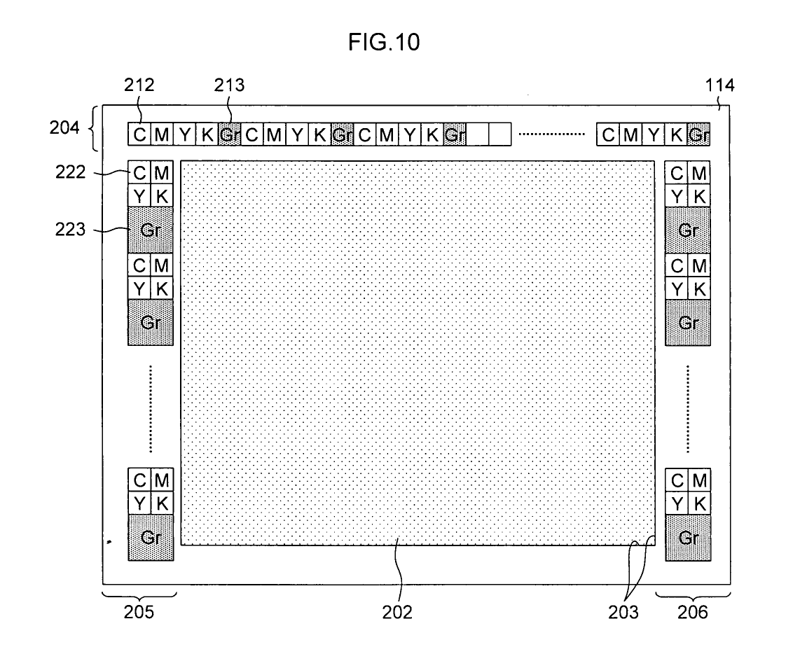

Consequently, the inkjet recording apparatus 100 relating to the present embodiment carries out the operation illustrated in the flowchart in FIG. 9. In other words, firstly, the picture to be printed is adjusted (step S11). In this step, before carrying out the actual printing task (main printing), a so-called test print (correction print) is performed, the output results of same are judged visually, and tasks such as judging suitability and adjusting color (color correction) are carried out. In this case, as measurement samples, each single color patch of YMCK and a patch of gray (e.g. 50% gray) are recorded on the printing surface of the recording medium 114 (see FIG. 10), and these are read in by the in-line determination unit 144, and the colorimetry is carried out.

FIG. 10 illustrates one example of measurement patches. FIG. 10 is an example in which color patches are formed in the margins (non-image portions) 204, 205, 206 to the outside of the image forming region 202 on the recording medium 114. The image forming region 202 is a region where the desired image is formed, which is cut along a cutting line 203 after image formation, thereby removing the surrounding non-image portion and leaving the image forming region as a printed item product.

In FIG. 10, monochrome color patches 212 and 222 of YMCK and gray (for example, 50% gray) patches 213, 223 are formed repeatedly in the margins 204, 205, 206 of the recording medium 114, in the lateral direction (breadthways direction perpendicular to the conveyance direction) and the longitudinal direction (direction parallel to the conveyance direction).

A desirable mode is one where, as color patches 212 and 222 of the respective single colors of YMCK, apart form a halftone region (e.g. 50%) and solid region (100%), small dot to large dot gradations (for example, 10%, 30%, 50%, 70%, 90%) are also formed. Furthermore, the gray patches 213 and 223 are images formed by composite images (the three colors of YMC in the present example).

The data for ejecting droplets to form measurement patches of this kind is stored in the memory 174, program memory 190, or the like, of the inkjet recording apparatus 100, and this data is read out according to requirements. Furthermore, the patch output conditions can be set and corrected on the basis of the information in the output conditions memory 194.

In FIG. 10, the patches 212, 213, 222, 223 are formed in the margins 204, 205, 206 outside the image forming region 202, but in printing other than main printing, it is possible to form patches over the whole surface of the printing surface including the image forming region 202.

In this way, by repeatedly forming patterns of patches of respective colors in the lateral direction and vertical direction on the printing surface, a plurality of individual patches of respective colors are formed in different positions on the printing surface. By performing colorimetry at respective positions of the same color patch formed at different positions and measuring differences in the color values with difference in the position, it is possible to ascertain color variations within the image surface. Furthermore, similarly, by comparing the colorimetry results between the recording media within a job which performs printing of a plurality of sheets (between the first and second sheets, and between the first and hundredth sheets, for example), it is possible to ascertain color variations between recording media (between sheets of paper).

If the picture is judged to be satisfactory at the step of picture adjustment in FIG. 9 (step S11), printing relating to the job (main printing) is started on the basis of these output conditions. Furthermore, the output conditions in this case, and the colorimetry results of patches judged actually to be satisfactory are stored for each respective job (step S12).

The information elements recorded as output conditions are, for example, the paper type, a color correction table, a correction curve (straight line), halftone type, number of graduated tones, and the like.

The information such as the output conditions is stored in the output conditions memory 194 illustrated in FIG. 7. Before the job is carried out, the operator can input additional information for identifying the job, such as the main name of the party requesting the printed item (client name), date and time, printed item name (title), serial number, and other text information, via the input apparatus 197 of the operating unit 196. Furthermore, in order to achieve more efficient searching, it is also possible to add information which specifies the type of printed item, such as “publicity (leaflet)”, “catalogue”, “publication”, and the like. This additional information is associated with the output conditions, and the like, for each job, and stored in the output conditions memory 194. A desirable composition is one where the date and time information is added automatically, by using a calendar and clock function of the system control 172, or the like.

During execution of a job, as illustrated in FIG. 10, as well as recording a target image on the image forming region 202, patches 212, 213, 222 and 223 are recorded in the margins thereof, and these patches are monitored by the in-line determination unit 144 (step S13 in FIG. 9). A desirable mode is one in which reading of patches and colorimetry are carried out in respect of all of the sheets in a job, while printing is being executed, but it is also possible to adopt a mode in which the patches are monitored each time a specified number of sheets has been printed (monitoring by thinning).

It is judged whether or not the results are within the acceptable range by comparing the colorimetry results of the patch obtained by the monitoring process and the colorimetry results stored at step S12 (step S14). For example, it is possible to judge automatically whether the result is satisfactory or unsatisfactory, by taking as the acceptable range any case where the difference ΔE in the color hue value in a CIE (International Commission on Illumination) standard L*a*b* color system is equal to or less than a prescribed reference value (for example, ΔE≦3). It is also possible to adopt a mode in which, instead of automatic judgment or in combination with same, an operator inputs a satisfactory or unsatisfactory indication on the basis of visual judgment. Furthermore, the color space used for colorimetry may be a CIE XYZ color space, a CIE Luv color space, an RGB color space, or the like.

If the judgment verdict is satisfactory (within acceptable range) at step S14, then printing is continued without any modifications, but if the verdict is unsatisfactory (outside acceptable range), then color correction is applied by means of CMS (color management system) or calibration (step S15). In performing color correction, if necessary, patches are formed on the whole of the printing surface, the variation in color with the position on the printing surface is checked, and the picture is adjusted again.

After the correction performed in step S15, output conditions indicating how the color has been corrected (the output conditions after correction) and the patch measurement results are stored (step S16). In this case, a desirable mode is one where the information stored at step S12 is updated to the most recent information obtained at step S16, while being kept in history. If there are limits on the storage capacity of the output conditions memory 194, the information may be overwritten, but by accumulating a history of past conditions, and the like, a merit is obtained in that this information can be used to analyze problems, after the fact.

After step S16, the procedure returns to step S13 and the processing described above (steps S13 to S16) is repeated. The information updated at step S16 is used as a judgment reference in the subsequent step S14.

In this way, by carrying out picture adjustment (steps S15 to S16) each time there is a color variation exceeding the acceptable range, it is possible to keep uniform output quality (color stability) within a job.

It is also possible to envisage a scenario in which, if a change exceeding the acceptable range is determined by monitoring the patches, a certain number of printed items are output before correction for remedying this change is reflected in printing. Desirably, prints which do not reflect correction (unsatisfactory prints) are output and stacked separately from the normal prints (prints of output image quality within the acceptable range), and therefore a desirable mode is one which comprises a device (not illustrated) for automatically switching the output path (output tray) between unsatisfactory prints and normal prints.

The system controller 172 described in FIG. 7 performs control for switching the output destination (stacker switching control) on the basis of the monitoring results obtained by the in-line determination unit 144. If a color value difference exceeding the acceptable range has been determined by the in-line determination unit 144, then the output path is switched and the unsatisfactory print is guided to a dedicated output tray. After the correction in steps S15 to S16, the output path is returned to a normal path and normal prints are stacked in the prescribed stacking location.

According to the present embodiment, since it is possible to control color correction in real time by monitoring patches by means of the in-line determination unit 144, there is little wasteful printing. Furthermore, it is also possible to automatically sort good prints from unsatisfactory prints.

### Device for Improving Reproducibility of Image Quality Between Jobs

When printing the same job, even if time (years, months or days) has passed since a job was output previously, it is necessary for exactly the same picture to be output. However, in actual practice, the output image quality (color stability and density, and the like) is liable to change in comparison with the previous output, in accordance with the state of the printing apparatus, deterioration over time, and ambient changes.

In order to avoid this, the previous output conditions and measurement results are used as a model. Information such as the output conditions of a job that has been printed in the past are stored in the output conditions memory 194, and therefore the operator searches for information relating to the job in question, amongst the accumulated information in the memory, and reads out this information and sets up the printing apparatus (inkjet recording apparatus 100) accordingly. In this search process, the desired information can be found by inputting keywords indicating additional information, such as the client name, printed item name, printing date/time, and the like. Furthermore, it is also possible to narrow the search by category (genre), such as “publicity (leaflet)” “catalogue”, “publication”, and the like. The functions of this kind of search processing are carried out by the system controller 172 which is illustrated in FIG. 7.

In this way, even if the conditions of the printing apparatus and the environment are different to the previous time, by provisionally outputting a picture under the same output conditions as the previous time and then monitoring by means of the in-line determination unit 144 similarly to the in-job control described in FIG. 9, the differences with respect to the previous output results (measurement results) can be confirmed (steps S11 to S14 in FIG. 9). If the result is satisfactory (within acceptable range), then printing can be continued without modification, but if the result is unsatisfactory (outside acceptable range), then color correction by CMS (color management system) or calibration is applied (step S15 in FIG. 9). In this case, the output conditions and patch measurement results after applying color correction are recorded again (step S15 in FIG. 9). This process is repeated and if there is a difference (exceeding an acceptable value) with respect to the previous job, then the picture is adjusted by color conversion, and the image quality (color stability and density, etc.) is made to become uniform both between the jobs and within the same job.

If the circumstances are such that it is difficult to match the color stability completely, then it is possible to identify particular colors which are especially important to the client and to priorities matching of those colors. If it is wished to guarantee a particular color hue in the L*a*b* color space, then that particular color hue is corrected so as to be reproducible in the color gamut. To give one example, in the case of a cosmetics catalogue, for instance, the client may attach special importance to the skin color in particular. In this case, color stability which prioritizes the reproduction of the skin color desired by the client is required. Furthermore, if there is a particular color which is emphasized by the client in this way, then desirably, this information (client request items) is input as additional information and stored in the output conditions memory 194 together with the job output conditions.

### Example of Composition for Improving Color Stability in Job and Between Jobs

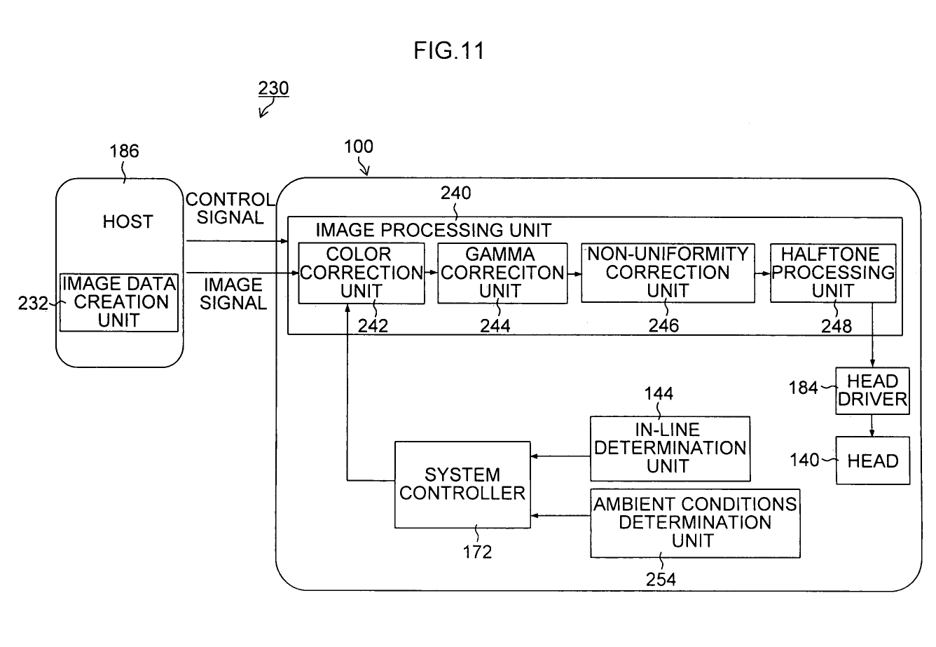

FIG. 11 is a principal block diagram relating to color correction and image output in a printing system including an inkjet recording apparatus 100. In FIG. 11, elements which are the same as or similar to the composition in FIG. 7 are labeled with the same reference numerals.

The printing system 230 illustrated in FIG. 11 is constituted by a host computer 186 (hereinafter, called “host 186”) and a printer which is an image forming apparatus (the inkjet recording apparatus 100 here, and will be called “printer 100” hereinafter). In the case of a commercial printing system 230, in contrast to a domestic system, the location where image data is created (production department) and the location where image formation on the recording medium is carried out (printing department) are often different from each other. For example, the production department is located in a city center and the printing department is located in a suburban area or out-of-town location, and the host 186 in the production department and the printer 100 in the print department are connected via high-speed communications lines.

In the present embodiment, the host 186 comprises an image data creation unit 202 which creates image data that is sent to the printer 100 (also called “transmission image data”), and a print instruction is issued from the host 186 to the printer 100 by means of a control signal, and printable image data is input to the printer 100.

In the present embodiment, the transmission image data is image data in raster format. If the printer 100 is a four-color ink printer using C (cyan), M (magenta), Y (yellow) and K (black), then the transmission image data is constituted by a group of pixels having density values (for example, 8-bit tone values) for each color of C, M, Y and K.

In the image data creation unit 232 of the host 186, for example, various image processing steps, such as rasterization, color conversion, tone conversion, and the like, are carried out. The image data creation step 232 is constituted by a CPU (Central Processing Unit) and a RIP (Raster Image Processor). In the rasterization process, data other than raster format data is converted to image data in a raster format. In the color conversion processing, conversion between color coordinates (for example, RGB coordinates, CMYK coordinates, L*a*b* coordinates) is performed and differences in color reproduction gamut between devices occurring due to the type of printer 100 are corrected. In the tone conversion process, for example, the density values (multiple tone values) of the respective colors (for example, C, M, Y, K) are converted in accordance with the user's wishes, for example.

Furthermore, the image data creation unit 232 of the host 186 carries out image processing (for example, color conversion processing or tone conversion processing) for optimizing to standard ambient conditions (for example, ambient conditions with a temperature of 25° C.). The transmission image data created by the image data creation unit 232 of the host 186 is sent to the printer 100 by means of a communications unit (not illustrated). If printing the same contents that have been printed in the past, image data is sent on the basis of the output conditions recorded in the previous job, in accordance with the information recorded in the output conditions memory 194 illustrated in FIG. 7. Furthermore, after sending the image data, the host 186 then sends a control signal indicating an image output instruction, to the printer 100.

It is also possible for the function of the image data creation unit 232 in the host 186, to be installed inside the printer 100.

The printer 100 comprises an image processing unit 240 for processing the output image signal, a head driver 184, a head 140, an in-line determination unit 144, an ambient conditions determination unit 254 and a system controller 172.

The image processing unit 240 is constituted by a color correction unit 242, a gamma correction unit 244, a non-uniformity correction unit 246 and a halftone processing unit 248.

The ambient conditions determination unit 254 is constituted by at least one of a temperature sensor and a humidity sensor. Desirably, this unit comprises a temperature sensor, at the least.

The location of the ambient conditions determination unit 254 is not limited in particular, but desirably, it is close to the position where the ink lands on the recording medium, from the viewpoint of accurately ascertaining the droplet ejection conditions. For example, the printing temperature is measured by using a radiation thermometer. Alternatively, it is also possible to measure the temperature of the air surrounding the printing position, using a temperature measurement device, such as a thermocouple. Apart from this, it is also possible to measure the temperature at a position inside or outside the frame of the printer 100 which has a correlation with the printing position, and to convert this temperature to a printing temperature.

The system controller 172 holds correction data used for correction processing in order to correct the density values of the respective colors (for example, C, M, Y, K) of the image data in accordance with the ambient conditions, and the correction unit 242 selects correction data (parameters) corresponding to the ambient conditions determined by the ambient conditions determination unit 254. For example, the conditions in a standard state (standard ambient conditions) and the determined ambient conditions (ambient conditions at the start of printing) are compared, and correction data is selected on the basis of the result of this comparison.

The correction data according to the present example stipulates correction amounts in accordance with the difference between the ambient conditions at the start of printing and the standard ambient conditions, and color conversion processing for converting the density values by using the selected correction data is carried out in respect of the input image data (C, M, Y, K), thus yielding image data which has been corrected for ambient change (C′, M′, Y′, K′).

The corrected image data (C′, M′, Y′, K′) is sent to the gamma correction unit 244. In the gamma correction unit 244, gamma correction processing is carried out to correct tonal changes in the output apparatus (printer 100) caused by factors such as differences or deterioration in the performance of the electronic circuit components. For example, tone value correction is carried out using a 1D-LUT (one-dimensional look-up table) for each color.

In the non-uniformity correction unit 246, non-uniformity correction processing is carried out to correct density non-uniformities on the recording medium, by correcting fluctuations in the ejection characteristics of the head 140. For example, for each nozzle of the head 140, the density values of the corresponding image data (pixel positions) are corrected by using the 1D-LUT.

In the halftone processing unit 248, a halftoning process is carried out to convert image data comprising multiple tone values (for example, 8-bit data) into image data of a number of tones which can be ejected by the nozzles of the head 140 (for example, 2-bit data). For example, a halftoning process is carried out by using an error diffusion method or threshold value matrix method, or the like.

The image data which has been converted into the number of tones required in the head 140, by passing through the color correction unit 242, the gamma correction unit 244, the non-uniformity correction unit 246 and the halftone processing unit 248 is converted into a drive signal for the head 140 by the head driver 184, and is then supplied to the head 140. By means of this drive signal, the head 140 is driven and printing is carried out.

FIG. 11 illustrates an example in which the image processing unit 240 carries out processing in the sequence—the color processing, gamma correction processing, non-uniformity correction processing, and halftone processing (i.e. color processing→gamma correction processing→non-uniformity correction processing→halftone processing), but the positions and order of these processes are not limited to the present example. Various different processing methods are possible, for instance, other processes can be added and the sequence can be altered.

As stated above, a print job may involve printing a plurality of prints from one set of image data. In this case, after printing a first print according to the sequence described above, the image data which has undergone a halftoning process is stored in a memory device (not illustrated), and each time a print is made from this stored image data, a sequence of generating a head drive signal by the head driver 184 and driving the head 140 is repeated, thereby generating a plurality of prints.

In this, desirably, the acceptable amount of change in the output image quality is set to approximately one half of the amount of change which is actually acceptable. During printing, the patches are monitored by the in-line determination unit 144 described in FIG. 9 (steps S13 to S14 in FIG. 9), and if change exceeding the acceptable range is determined, then color correction processing (step S15) is carried out. When this color correction has been carried out, in the image processing unit 240, image processing is carried out again to reflect the color correction, thereby creating image data which is suited to the new ambient conditions and state of the printing apparatus, and the like, and printing is automatically repeated on the basis of this image data.

With correction carried out at the start of the job only, it is not possible to respond as appropriate to variation during the job, but by constantly measuring the output patches and monitoring same by means of the in-line determination unit 144, differences with respect to the initial state are determined constantly, and by using this change as feedback, it is possible to maintain uniform quality (color stability and density) within a job.

By controlling color correction in real time in this way, it is possible to automate the production of high-quality printed items in conjunction with digital printing technology, and it is possible to achieve improvements in productivity.

Furthermore, in respect of the reproducibility of image quality between jobs where the same contents that have been printed in the past are to be printed again, by starting output on the basis of the output conditions of a previous job which is taken as a model, and monitoring differences with respect to the colorimetry results of the previous jobs which forms the model, by means of the in-line determination unit 144, it is possible to reproduce the printed item quality of a particular job, and to maintain this quality during the job, even in circumstances where there is variation in various factors, such as the main apparatus, the head 140, the operating environment, and so on.

Below, various methods of color correction processing in the color correction unit 242 are described.

### Example 1

### Multi-Dimensional Look-Up Table Method

One method which enables highly accurate color conversion throughout the whole color range is a method using a multi-dimensional look-up table. This is the method generally used in a CMM (color management modules) which corrects differences in the color reproduction gamut between devices.

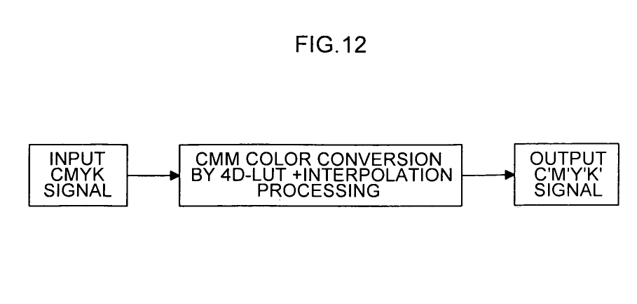

For example, as illustrated in FIG. 12, there is a method where color conversion is carried out based on a multi-dimensional (in the present example, a four-dimensional) look-up table (grid point data) and an interpolation process which interpolates between the grid points thereof, in respect of the a CMYK signal input to the printer 100, thereby yielding corrected image data comprising a C′M′Y′K′ signal. A multi-dimensional look-up table corresponds to an ICC profile, which is a standard set by the ICC (International Color Consortium).

This 4D-LUT (four-dimensional look-up table) is created in advance by a similar operation to so-called “color matching”. In other words, a device-linked profile is created by taking a target color space as the color reproduction gamut under standard ambient conditions and taking the printer profile as the color reproduction gamut under particular ambient conditions (for example, the standard ambient conditions+10° C.).

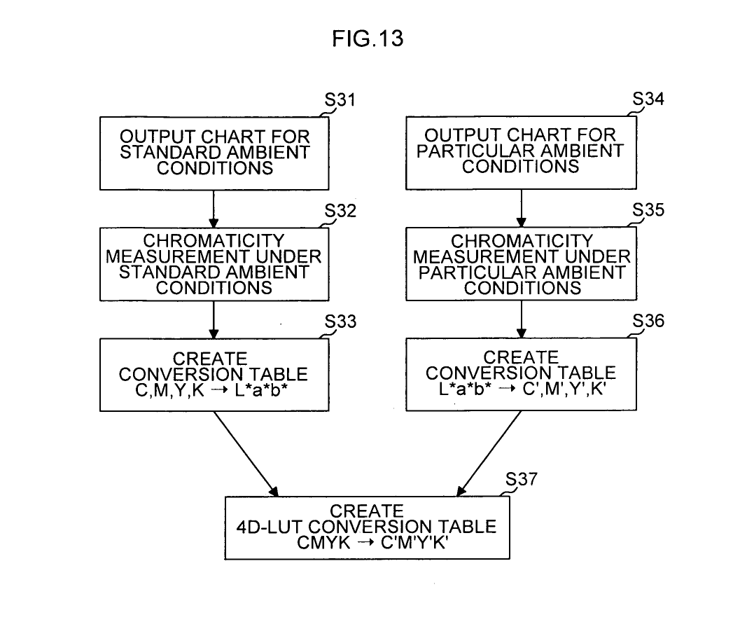

More specifically, as illustrated on the left-hand side in FIG. 13, image formation of a test pattern (chart for standard ambient conditions) is carried out under standard ambient conditions (step S31), chromaticity measurement of the image thus formed is carried out (step S32), and on the basis of these measurement results, a table for converting from a CMYK signal to a L*a*b* signal is created (step S33). On the other hand, as illustrated on the right-hand side in FIG. 13, image formation of a test pattern (chart for particular ambient conditions) is carried out under respective ambient conditions (step S34), chromaticity measurement of the image thus formed is carried out (step S35), and on the basis of these measurement results, a table for converting from a L*a*b* signal to a C′M′Y′K′ signal is created (step S36). Thereupon, a 4D-LUT for converting from a CMYK signal to a C′M′Y′K′ signal is created on the basis of the two conversion tables created at steps S33 and S36 (step S37). In this way, a 4D-LUT for each set of ambient conditions is created.

For example, it is supposed that the ambient temperature range in which the printer 100 is used is 20° C. to 30° C., the standard ambient temperature is 25° C. and the acceptable range of variation in the ambient temperature in which color change is not perceptible is 5° C. Furthermore, a 4D-LUT (four-dimensional look-up table) for correction is created in advance on the basis of one half of the acceptable range of variation in the ambient temperature (in other words, 2.5° C. step). In this case, five 4D-LUTs corresponding respectively to 20° C., 22.5° C., 25° C., 27.5° C. and 30° C. are created. The 4D-LUT is switched in accordance with the judgment of the system controller 172 which corresponds to the ambient change judgment unit, and correction processing of the image data is carried out accordingly.

The divisions of the ambient temperature are set to one half (2.5° C.) of the acceptable temperature range (5° C.) of color change vision perception in order to further raise the color matching accuracy of the image in respect of change in the ambient temperature, and the divisions of the ambient temperature can be set appropriately so as to balance the degree of accuracy of color matching and the processing load. For example, it is possible to set the divisions of the ambient temperature to equal the acceptable temperature range in relation to visual perception of color change.

### Example 2

### Matrix Calculation Method

If it is supposed that there is little amount of change caused by the ambient conditions, or the like, then it is possible to execute color conversion by means of a more simple method. One simple manner of this kind is a matrix calculation method.

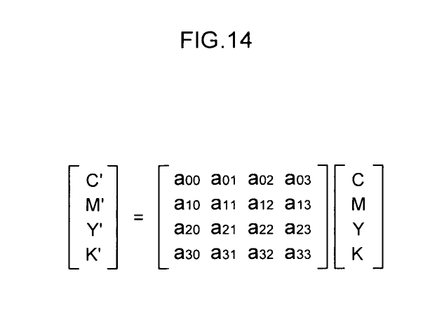

In FIG. 14, the matrix comprising the matrix coefficients aᵢⱼ (a₀₀ to a₃₃) can be determined by the variable which produces the minimum square error between the image data values after ambient change (C′, M′, Y′, K′) and the image data value (C, M, Y, K) in a standard state. Since this is executed by means of a relatively simple product-sum calculation, the hardware can be simplified. If the color conversion characteristics diverge from a linear matrix relationship, then partial error may occur in part of the color range, but it is possible to create a matrix for each set of ambient conditions, by means of a simple method, and to perform correctional processing by switching matrix in accordance with a judgment by the system controller 172 (ambient change judgment unit).

### One-Dimensional Look-Up Table Method

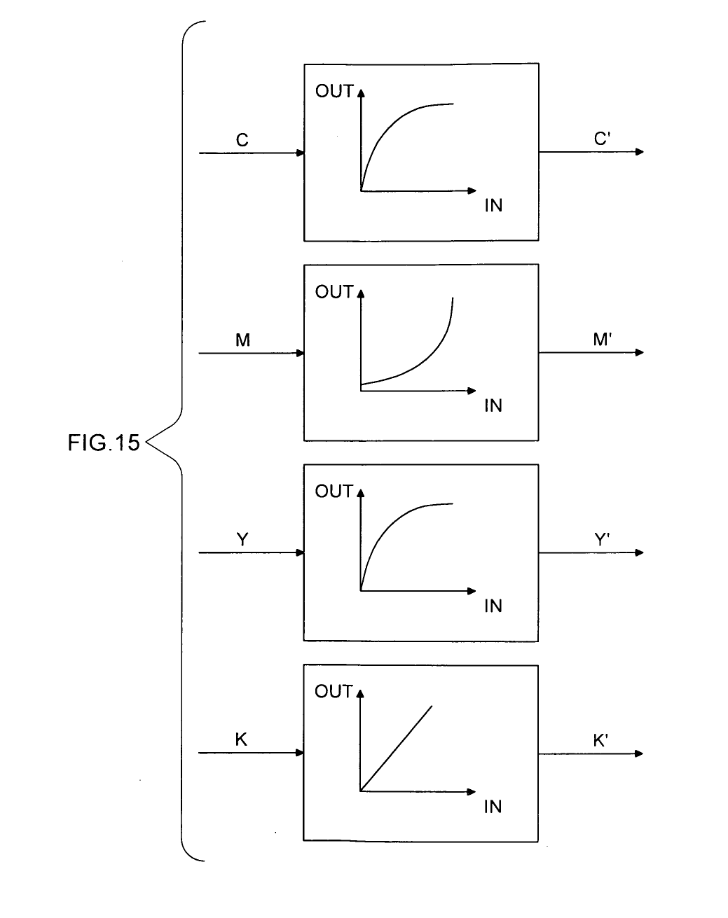

A most simple method is one using a one-dimensional look-up table (1D-LUT) for each color as illustrated in FIG. 15.

For example, a tone correction curve which achieves a gray balance of superimposed single colors is used as disclosed in Japanese Patent Application Publication No. 2001-245171 (see, in particular, FIGS. 8A to 8C). In terms of the particular color hue, it is desirable to focus on a gray tone in which color change is readily visible, but it is also possible to focus on a color having a greatest color change with the characteristics of the printer, a particular important color (for example, skin color, green, blue), or the like.

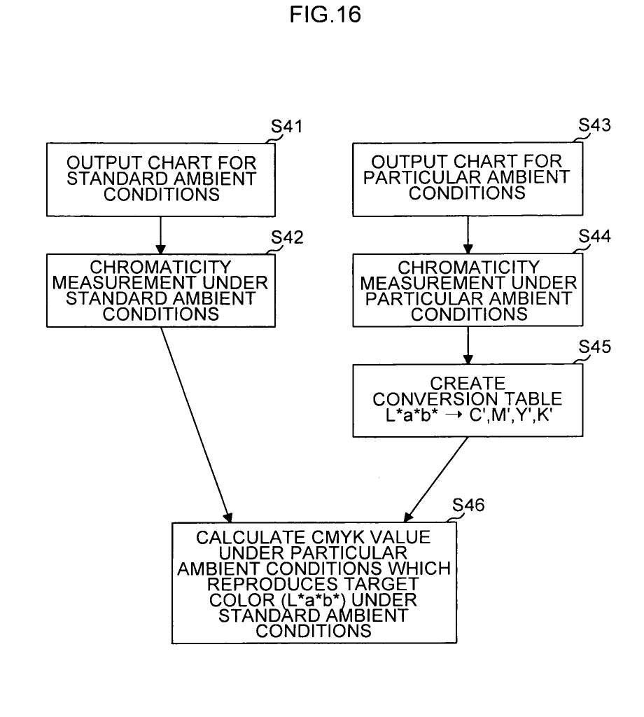

For example, in FIG. 16, a plurality of patches are selected in accordance with a particular color hue, charts are output (step S41 and S43) and chromaticity measurement is performed (step S42 and S46) respectively under standard ambient conditions and particular ambient conditions, and the target color chromaticity is calculated in respective of each density of the particular color hue. A table for converting L*a*b* coordinates to C′M′Y′K′ coordinates is created in respect of the particular ambient conditions (step S45). The CMYK value for reproducing a target chromaticity under the standard ambient conditions is calculated using the conversion table (L*a*b*→CMYK) (step S46). A one-dimensional tone correction curve (1D-LUT) is obtained by carrying out this processing in respect of a plurality of density values of the particular color hue;

The chromaticity change described above depends on the amount of treatment liquid applied. The amount of treatment liquid applied depends on the type of paper, for instance. Therefore, if the LUT and matrix coefficients for color correction are dependent on the paper type (namely, a composition where the LUT and matrix coefficients used are switched in accordance with the type of paper), then the accuracy of correction is further improved, which is desirable.

### First Modification of Embodiment

In FIG. 1, an in-line determination unit 144 is provided inside the inkjet recording apparatus 100 as a colorimetric device, but in the case of a composition where an in-line determination unit cannot be provided inside the apparatus, an alternative method is one where an external reading apparatus, such as a scanner, is used. In this case, the printed item is set in the reading apparatus and read in after printing. Use of off-line reading (measurement) of this kind is also possible.

### Second Modification of Embodiment

In FIG. 1, an inkjet type ejection head is used as a treatment liquid deposition device, but instead of this, it is also possible to use an application roller, or the like.

### Examples of Permeation Suppression Agent, Treatment Liquid, and Ink

Examples of the permeation suppression agent, the treatment liquid and the ink used in the present embodiment illustrated in FIG. 1 are described below.

### Permeation Suppression Agent

A mixed solution was prepared by mixing 10 g of a dispersion stabilizer resin (Q-1) having the following structure:

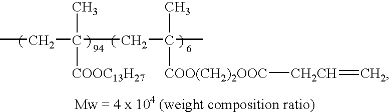

100 g of vinyl acetate and 384 g of Isopar H (made by Exxon), and was heated to a temperature of 70° C. while being agitated in a nitrogen gas flow. Then, 0.8 g of 2,2′-azobis(isovaleronitrile) (A.I.V.N.) was added as a polymerization initiator, and the mixture was made react for 3 hours. 20 minutes after adding the polymerization initiator, white turbidity was produced and the reaction temperature rose to 88° C. A further 0.5 g of polymerization initiator was added and after making reaction for 2 hours, the temperature was raised to 100° C. and the mixture was agitated for 2 hours. Then, vinyl acetate that had not reacted was removed. The mixture was cooled and then passed through a 200-mesh nylon cloth. The white dispersed material thereby obtained was a latex having a polymerization rate of 90%, an average particle size of 0.23 μm and good monodisperse properties. The particle size was measured with a CAPA-500 manufactured by HORIBA, Ltd.

A portion of the white dispersed material was placed in a centrifuge (for example, rotational speed: 1×10⁴ r.p.m.; operating duration: 60 minutes), and the precipitated resin particles were complemented and dried. The weight-average molecular weight (Mw), glass transition point (Tg) and minimum film forming temperature (MFT) of the resin particles were measured as follows: Mw was 2×10⁵ (GPC value converted to value for polystyrene), Tg was 38° C. and MFT was 28° C. The permeation suppression agent liquid prepared as described above was deposited onto the recording paper. During deposition, the recording paper was heated by the drum, and after the deposition, the Isopar H was evaporated off by blowing a hot air flow.

### Ink

The ink used in the present embodiment is aqueous pigment ink that contains the following materials insoluble to the solvent (water): pigment particles as the coloring material, and polymer particles.

It is desirable that the concentration of the solvent-insoluble materials in the ink is not less than 1 wt % and not more than 20 wt %, taking account of the fact that the viscosity of the ink suitable for ejection is 20 mPa·s or lower. It is more desirable that the concentration of the pigment in the ink is not less than 4 wt %, in order to obtain good optical density in the image. It is desirable that the surface tension of the ink is not less than 20 mN/m and not more than 40 mN/m, taking account of ejection stability in the ink ejection head.

The coloring material in the ink may be pigment or a combination of pigment and dye. From the viewpoint of the aggregating characteristics when the ink comes into contact with the treatment liquid, a dispersed pigment in the ink is desirable for more effective aggregation. Desirable pigments include: a pigment dispersed by a dispersant, a self-dispersing pigment, a pigment in which the pigment particle is coated with a resin (hereinafter referred to as “microcapsule pigment”), and a polymer grafted pigment. Moreover, from the viewpoint of the aggregating characteristics of the coloring material, it is more desirable that the coloring material is modified with a carboxyl group having a low degree of disassociation.

There are no particular restrictions on the resin used for a microcapsule pigment, but desirably, it should be a compound of high molecular weight which has a self-dispersing capability or solubility in water, and contains an anionic group (acidic). Generally, it is desirable that the resin should have a number average molecular weight in the approximate range of 1,000 to 100,000, and especially desirably, in the approximate range of 3,000 to 50,000. Moreover, desirably, this resin can dissolved in an organic solvent to form a solution. By limiting the number average molecular weight of the resin to this range, it is possible to make the resin display satisfactory functions as a covering film for the pigment particle, or as a coating film in the ink composition.

The resin may itself have a self-dispersing capability or solubility, or these functions may be added or introduced. For example, it is possible to use a resin having an introduced carboxyl group, sulfonic acid group, or phosphonic acid group or another anionic group, by neutralizing with an organic amine or alkali metal. Moreover, it is also possible to use a resin into which one or two or more anionic groups of the same type or different types have been introduced. In the present embodiment, it is desirable to use a resin which has been neutralized by means of a salt and which contains an introduced carboxyl group.

There are no particular restrictions on the pigment used in the present embodiment, and specific examples of orange and yellow pigments are: C.I. Pigment Orange 31, C. I. Pigment Orange 43, C. I. Pigment Yellow 12, C. I. Pigment Yellow 13, C.I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 151, C. I. Pigment Yellow 155, C.I. Pigment Yellow 180, and C.I. Pigment Yellow 185. Specific examples of red and magenta pigments are: C.I. Pigment Red 2, C. I. Pigment Red 3, C.I. Pigment Red 5, C. I. Pigment Red 6, C.I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C.I. Pigment Red 166, C. I. Pigment Red 177, C. I. Pigment Red 178, and C.I. Pigment Red 222.

Specific examples of green and cyan pigments are: C. I. Pigment Blue 15, C. I. Pigment Blue 15:2, C. I. Pigment Blue 15:3, C. I. Pigment Blue 16, C. I. Pigment Blue 60, and C.I. Pigment Green 7.

Specific examples of a black pigment are: C.I. Pigment Black 1, C.I. Pigment Black 6, and C.I. Pigment Black 7.

It is desirable in the present embodiment that the colored ink liquid contains polymer particles that do not contain any colorant, as a component for reacting with the treatment liquid. The polymer particles can improve the image quality by strengthening the ink viscosity raising action and the aggregating action through reaction with the treatment liquid. In particular, a highly stable ink can be obtained by adding anionic polymer particles to the ink.

By using the ink containing the polymer particles that produce the viscosity raising action and the aggregating action through reaction with the treatment liquid, it is possible to increase the quality of the image, and at the same time, depending on the type of polymer particles, the polymer particles may form a film on the recording medium, and therefore beneficial effects can be obtained in improving the wear resistance and the waterproofing characteristics of the image.

The method of dispersing the polymer particles in the ink is not limited to adding an emulsion of the polymer particles to the ink, and the resin may also be dissolved, or included in the form of a colloidal dispersion, in the ink.

The polymer particles may be dispersed by using an emulsifier, or the polymer particles may be dispersed without using any emulsifier. For the emulsifier, a surface active agent of low molecular weight is generally used, and it is also possible to use a surface active agent of high molecular weight. It is also desirable to use a capsule type of polymer particles having an outer shell composed of acrylic acid, methacrylic acid, or the like (core-shell type of polymer particles in which the composition is different between the core portion and the outer shell portion).

The polymer particles dispersed without any surface active agent of low molecular weight are known as the soap-free latex, which includes polymer particles with no emulsifier or a surface active agent of high molecular weight. For example, the soap-free latex includes polymer particles that use, as an emulsifier, the above-described polymer having a water-soluble group, such as a sulfonic acid group or carboxylic acid group (a polymer with a grafted water-soluble group, or a block polymer obtained from a monomer having a water-soluble group and a monomer having an insoluble part).

It is especially desirable in the present embodiment to use the soap-free latex compared to other type of resin particles obtained by polymerization using an emulsifier, since there is no possibility that the emulsifier inhibits the aggregating reaction and film formation of the polymer particles, or that the free emulsifier moves to the surface after film formation of the polymer particles and thereby degrades the adhesive properties between the recording medium and the ink aggregate in which the coloring material and the polymer particles are combined.

Examples of the resin component added as the polymer particles to the ink include: an acrylic resin, a vinyl acetate resin, a styrene-butadiene resin, a vinyl chloride resin, an acryl-styrene resin, a butadiene resin, and a styrene resin.

In order to make the polymer particles have high speed aggregation characteristics, it is desirable that the polymer particles contain a carboxylic acid group having a low degree of disassociation. Since the carboxylic acid group is readily affected by change of pH, then the polymer particles containing the carboxylic acid group easily change the state of the dispersion and have high aggregation characteristics.

The change in the dispersion state of the polymer particles caused by change in the pH can be adjusted by means of the component ratio of the polymer particle having a carboxylic acid group, such as ester acrylate, or the like, and it can also be adjusted by means of an anionic surfactant which is used as a dispersant.

Desirably, the resin constituting the polymer particles is a polymer that has both of a hydrophilic part and a hydrophobic part. By incorporating a hydrophobic part, the hydrophobic part is oriented toward to the inner side of the polymer particle, and the hydrophilic part is oriented efficiently toward the outer side, thereby having the effect of further increasing the change in the dispersion state caused by change in the pH of the liquid. Therefore, aggregation can be performed more efficiently.

Examples of commercially available resin emulsion include: Joncryl 537 and 7640 (styrene-acrylic resin emulsion, manufactured by Johnson Polymer), Microgel E-1002 and E-5002 (styrene-acrylic resin emulsion, manufactured by Nippon Paint), Voncoat 4001 (acrylic resin emulsion, manufactured by Dainippon Ink and Chemicals), Voncoat 5454 (styrene-acrylic resin emulsion, manufactured by Dainippon Ink and Chemicals), SAE-1014 (styrene-acrylic resin emulsion, manufactured by Zeon Japan), Jurymer ET-410 (acrylic resin emulsion, manufactured by Nihon Junyaku), Aron HD-5 and A-104 (acrylic resin emulsion, manufactured by Toa Gosei), Saibinol SK-200 (acrylic resin emulsion, manufactured by Saiden Chemical Industry), and Zaikthene L (acrylic resin emulsion, manufactured by Sumitomo Seika Chemicals). However, the resin emulsion is not limited to these examples.

The weight ratio of the polymer particles to the pigment is desirably 2:1 through 1:10, and more desirably 1:1 through 1:3. If the weight ratio of the polymer particles to the pigment is less than 2:1, then there is no substantial improvement in the aggregating force of the aggregate formed by the cohesion of the polymer particles. On the other hand, if the weight ratio of the polymer particles to the pigment is greater than 1:10, the viscosity of the ink becomes too high and the ejection characteristics, and the like, deteriorate.

From the viewpoint of the adhesive force after the cohesion, it is desirable that the molecular weight of the polymer particles added to the ink is no less than 5,000. If it is less than 5,000, then beneficial effects are insufficient in terms of improving the internal aggregating force of the ink aggregate, achieving good fixing characteristics after transfer to the recording medium, and improving the image quality.

Desirably, the volume-average particle size of the polymer particles is in the range of 10 nm to 1 μm, more desirably, the range of 10 nm to 500 nm, even desirably 20 nm to 200 nm and particularly desirably, the range of 50 nm to 200 nm. If the particle size is equal to or less than 10 nm, then significant effects in improving the image quality or enhancing transfer characteristics cannot be expected, even if aggregation occurs. If the particle size is equal to or greater than 1 μm, then there is a possibility that the ejection characteristics from the ink head or the storage stability will deteriorate. Furthermore, there are no particular restrictions on the volume-average particle size distribution of the polymer particles and they may have a broad volume-average particle size distribution or they may have a monodisperse volume-average particle size distribution.

Moreover, two or more types of polymer particles may be used in combination in the ink.

Examples of the pH adjuster added to the ink in the present embodiment include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the present embodiment that the ink contains a water-soluble organic solvent, from the viewpoint of preventing nozzle blockages in the ejection head due to drying. Examples of the water-soluble organic solvent include a wetting agent and a penetrating agent.

Examples of the water-soluble organic solvent in the ink are: polyhydric alcohols, polyhydric alcohol derivatives, nitrous solvents, monohydric alcohols, and sulfurous solvents. Specific examples of multivalent alcohols include ethylene glycol, diethylene glycol, propylene glycol, butylene glycol, triethylene glycol, 1,5-pentane diol, 1,2,6-hexane triol, glycerine, and so on. Specific examples of multivalent alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, diglycerine ethylene oxide additives, and so on. Specific examples of solvents containing nitrogen include pyrrolidone, N-methyl-2-pyrrolidone, cyclohexyl pyrrolidone, triethanol amine, and so on. Specific examples of alcohols include ethanol, isopropyl alcohol, butyl alcohol, benzyl alcohol, and other alcohols. Specific examples of solvents containing sulphur include thiodiethanol, thiodiglycerol, sulfolane, dimethyl sulfoxide, and so on. In addition, propylene carbonate, ethylene carbonate, and the like can be used.

The ink used in the present embodiment may contain a surfactant.

Examples of the surfactant in the ink include: in a hydrocarbon system, an anionic surfactant, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, and a polyoxyethylene alkyl sulfonate ester salt; and a non-ionic surfactant, such as a polyoxyethylene alkyl ether, a polyoxyethylene alkyl aryl ether, a polyoxyethylene fatty acid ester, a sorbitan fatty acid ester, a polyoxyethylene sorbitan fatty acid ester, a polyoxyethylene alkyl amine, a glycerin fatty acid ester, and an oxyethylene oxypropylene block copolymer. Desirable examples of the surfactant further include: Surfynols (manufactured by Air Products & Chemicals), which is an acetylene-based polyoxyethylene oxide surfactant, and an amine oxide type of amphoteric surfactant, such as N,N-dimethyl-N-alkyl amine oxide.

Moreover, it is also possible to use the surfactants cited in Japanese Patent Application Publication No. 59-157636, pages 37 to 38, and Research Disclosure No. 308119 (1989). Furthermore, it is also possible to use a fluoride type (alkyl fluoride type), or silicone type of surfactant such as those described in Japanese Patent Application Publication Nos. 2003-322926, 2004-325707 and 2004-309806. It is also possible to use a surface tension adjuster of this kind as an anti-foaming agent; and a fluoride or silicone compound, or a chelating agent, such as ethylenediamine tetraacetic acid (EDTA), can also be used.

The surfactant contained in the ink has beneficial effects in raising the wettability on the solid or semi-solid aggregating treatment agent layer by reducing the surface tension, and therefore the aggregating action effectively progresses due to the increase in the contact surface area between the solid or semi-solid aggregating treatment agent layer and the ink.

It is desirable in the present embodiment that the ink has the surface tension of 10 mN/m to 50 mN/m. Moreover, from the viewpoint of simultaneously achieving good wetting properties on an intermediate transfer medium when recording by an intermediate transfer method, as well as finer size of the liquid droplets and good ejection characteristics, it is more desirable that the ink has the surface tension of 15 mN/m to 45 mN/m.

It is desirable in the present embodiment that the ink has the viscosity of 1.0 cP to 20.0 cP.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

### Treatment Liquid

It is desirable in the present embodiment that the treatment liquid (aggregating treatment liquid) has effects of generating aggregation of the pigment and the polymer particles contained in the ink by producing a pH change in the ink when coming into contact with the ink.

Specific examples of the contents of the treatment liquid are: polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, cumaric acid, thiophene carboxylic acid, nicotinic acid, derivatives of these compounds, and salts of these.

A treatment liquid having added thereto a polyvalent metal salt or a polyallylamine is the preferred examples of the treatment liquid. The aforementioned compounds may be used individually or in combinations of two or more thereof.

From the standpoint of aggregation ability with the ink, the treatment liquid desirably has a pH of 1 to 6, more desirably a pH of 2 to 5, and even more desirably a pH of 3 to 5.

The amount of the component that causes aggregation of the pigment and polymer particles of the ink in the treatment liquid is desirably not less than 0.01 wt % and not more than 20 wt % based on the total weight of the liquid. Where the amount of this component is less than 0.01 wt %, sufficient concentration diffusion does not proceed when the treatment liquid and ink come into contact with each other, and sufficient aggregation action caused by pH variation sometimes does not occur. Further, where the amount of this component is more than 20 wt %, the ejection ability from the inkjet head can be degraded.

From the standpoint of preventing the nozzles of inkjet heads from being clogged by the dried treatment liquid, it is preferred that the treatment liquid include an organic solvent capable of dissolving water and other additives. A wetting agent and a penetrating agent are included in the organic solvent capable of dissolving water and other additives.

The solvents can be used individually or in a mixture of plurality thereof together with water and other additives.

The content ratio of the organic solvent capable of dissolving water and other additives is desirably not more than 60 wt % based on the total weight of the treatment liquid. Where this amount is higher than 60 wt %, the viscosity of the treatment liquid increases and ejection ability from the inkjet head can be degraded.

In order to improve fixing ability and abrasive resistance, the treatment liquid may further include a resin component. Any resin component may be employed, provided that the ejection ability from a head is not degraded when the treatment liquid is ejected by an inkjet system and also provided that the treatment liquid will have high stability in storage. Thus, water-soluble resins and resin emulsions can be freely used.

An acrylic resin, a urethane resin, a polyester, a vinyl resin, and a styrene resin can be considered as the resin components. In order to demonstrate a sufficient function of improving the fixing ability, a polymer with a comparatively high molecular weight has to be added at a high concentration of 1 wt % to 20 wt %. However, where such a material is added to and dissolved in a liquid, the viscosity thereof increases and ejection ability is degraded. A latex can be effectively added as an adequate material that can be added to a high concentration, while inhibiting the increase in viscosity. Examples of latex materials include alkyl acrylate copolymers, carboxy-modified SBR (styrene-butadiene latex), SIR (styrene-isoprene) latex, MBR (methyl methacrylate-butadiene latex), and NBR (acrylonitrile-butadiene latex). From the standpoint of the process, the glass transition temperature Tg of the latex has a strong effect during fixing, and is desirably not lower than 50° C. and not higher than 120° C. Furthermore, from the standpoint of the process, the minimum film-formation temperature MFT also has a strong effect during fixing, and in order to obtain sufficient fixing at a low temperature, it is preferred that the MFT be not higher than 100° C., more desirably not higher than 50° C.

The aggregation ability may be further improved by introducing polymer microparticles of reverse polarity with respect to that of the ink into the treatment liquid and causing the aggregation of the pigment contained in the ink with the polymer microparticles.

The aggregation ability may be also improved by introducing a curing agent corresponding to the polymer microparticle component contained in the ink into the treatment liquid, bringing the two liquids into contact, causing aggregation and also crosslinking or polymerization of the resin emulsion in the ink component.

The treatment liquid used in the present embodiment may contain a surfactant.

Examples of suitable surfactants of a hydrocarbon system include anionic surfactants such as fatty acid salts, alkylsulfuric acid esters and salts, alkylbenzenesulfonic acid salts, alkylnaphthalenesulfonic acid salts, dialkylsulfosuccinic acid salts, alkylphosphoric acid esters and salts, naphthalenesulfonic acid formalin condensate, and polyoxyethylene alkylsulfuric acid esters and salts, and nonionic surfactants such as polyoxyethyelene alkyl ethers, polyoxyethylene alkylallyl ethers, polyoxyethylene fatty acid esters, sorbitan fatty acid esters, polyoxyethylene sorbitan fatty acid esters, polyoxyethylene alkylamines, glycerin fatty acid esters, and oxyethylene oxypropylene block copolymer. It is preferred that SURFYNOLS (made by Air Products & Chemicals), which is an acetylene-type polyoxyethylene oxide surfactant, be used. Amineoxide-type amphoteric surfactant such as N,N-dimethyl-N-alkylamineoxide is also a preferred surfactant.

A surfactant described in Japanese Patent Application Publication No. 59-157636, pages 37 to 38 and Research Disclosure No. 308119 (1989) can be also used. Fluorine-containing (fluorinated alkyl system) and silicone-type surfactants such as described in Japanese Patent Application Publication Nos. 2003-322926, 2004-325707, and 2004-309806 can be also used. These surface tension adjusting agents can be also used as an antifoaming agent. Chelating agents represented by fluorine-containing or silicone-type compounds and EDTA can be also used.

These agents are effective in reducing surface tension and increasing wettability on the recording medium. Further, even when the ink is the first to be deposited, effective aggregation action proceeds because of increased wettability of the ink and enlarged contact surface area of the two liquids.

It is desirable in the present embodiment that the treatment liquid has the surface tension of 10 mN/m to 50 mN/m. From the standpoint of improving the wettability on the intermediate transfer body and also size reduction ability and ejection ability of droplets, it is even more preferred that the surface tension be 15 mN/m to 45 mN/m.

It is desirable in the present embodiment that the treatment liquid has the viscosity of 1.0 cP to 20.0 cP.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

### Example of application to other apparatus compositions

In the embodiments described above, an inkjet recording apparatus 100 is described as an example of an image forming apparatus, but the scope of the present invention is not limited to this, and it may also be applied to image forming apparatuses based on other methods apart from an inkjet method, such as a laser recording method, electrophotographic method, or the like. For example, it is also possible to apply the present invention to color image recording apparatuses of various types, such as a thermal transfer recording apparatus equipped with a recording head which uses thermal elements functioning as recording elements, an LED electrophotographic printer equipped with a recording head having LED elements functioning as recording elements, or a silver halide photographic printer having an LED line type exposure head, or the like.

As is understood from the embodiments of the present invention described previously, the present specification includes disclosure of various technical ideas including the inventions described hereinafter.

One aspect of the invention is directed to an image forming apparatus comprising: a recording head for forming an image on a recording medium; a color correction processing device which performs a color correction processing with respect to an input image data; an image output controller which controls the recording head according to the image data after performing the color correction processing in such a manner that the image corresponding to the image data is formed on the recording medium; a patch forming controller which controls the recording head so as to form a patch for colorimetry on the recording medium; a memory device for storing an output condition for forming the image, and measured results of the patch for colorimetry formed under the output condition; and a correction data change device which changes a correction data used for the color correction processing performed by the color correction processing device, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

According to this aspect of the present invention, since measured results of a patch for colorimetry and stored measurement results are compared, and color correction is changed if the difference between the results exceeds an acceptable range, then it is possible to maintain target image quality (color stability, density, and the like). The color stability in a job can be guaranteed by the continuous monitoring in the job. Furthermore, it is also possible to reproduce the same image quality in different jobs.

An inkjet recording device as one aspect of the image forming apparatus according to the present invention has a liquid ejection head (recording head) in which are densely disposed a plurality of droplet ejection elements (ink chamber units), each of which has a nozzle (ejection port) for ejecting ink droplets for forming dots and a pressure generating element (e.g. a piezoelectric actuator, a heating element for generating a bubble by heating, or the like) generating ejection pressure. The inkjet recording device also has an ejection control device which controls ejection of droplets from the liquid ejection head based on ink ejection data (dot image data) generated from an input image, wherein an image is formed on a recording medium (image-rendering medium) by the droplets ejected from the nozzles.

For example, color conversion or halftoning processing is performed based on image data (printing data) that is input through an image input device, whereby ink ejection data corresponding to the colors of the ink is generated. The drive of the pressure generating elements corresponding to the nozzles of the liquid ejection head is controlled based on the ink ejection data, whereby the ink droplets are ejected from the nozzles.

In order to achieve high-resolution image output, a desirable mode is one using a recording head in which a large number of liquid droplet ejection elements (ink chamber units) are arranged at high density, each liquid droplet ejection element comprising a nozzle (ejection port) which ejects ink liquid, a pressure chamber corresponding to the nozzle, and a pressure generating device.

As a configuration example of such an inkjet type recording head, it is possible to use a full-line type head that has a nozzle line in which a plurality of ejection ports (nozzles) are arrayed over the entire width of the image-rendering medium. In this case, it is possible that a plurality of relatively short ejection head modules are combined, each of the ejection head modules being shorter than the entire width of the image-rendering medium, and these ejection head modules are connected together to configure a nozzle line that is as long as the length of the entire width of the image-rendering medium.

Although the full-line head is normally disposed along a direction perpendicular to a relative feeding direction of the image-rendering medium (relative conveying direction), the head may be disposed along a diagonal direction that has a predetermined angle with respect to the direction perpendicular to the conveying direction.

The conveying device which relatively moves the image-rendering medium and the head conveys the image-rendering medium with respect to the stopped (fixed) head, moves the head with respect to the stopped image-rendering medium, or moves both the head and the image-rendering medium. Note that when forming a color image using an inkjet head, heads may be disposed in relation to the colors of a plurality of inks (recording liquids), or a plurality of colors of inks may be ejected from one recording head.

Possible modes of the conveyance device are a conveyance drum (conveyance roller) having a round cylindrical shape which is able to rotate about a prescribed rotational axis, and a conveyance belt, and the like.

More specifically, the term “recording medium” includes various types of media, irrespective of material and size, such as continuous paper, cut paper, sealed paper, resin sheets, such as OHP sheets, film, cloth, a printed circuit board on which a wiring pattern, or the like, is formed, and an intermediate transfer medium, and the like.

Desirably, the memory device stores, before starting of the printing job, the output condition under which the image having an intended image quality has been formed and the measured results of the patch for colorimetry formed under the output condition; and the patch for colorimetry is formed and the colorimetry of that formed patch is performed during performing the printing job, and the correction data is changed when the difference between the measured results of that performed colorimetry and the measured results stored in the memory device before starting of the printing job exceeds the predetermined acceptable range.

According to this mode, the picture is adjusted at the start of a job, the output condition and measurement result of the patch for colorimetry considered to be satisfactory are stored, and printing can be performed during the job under that condition. Furthermore, during the execution of the job, a patch for colorimetry is formed and colorimetry of that patch is carried out and the output results are monitored, whereby color correction can be performed if the difference with respect to the result at the start of the job exceeds an acceptable range. By this means, it is possible to obtain stable image quality within the same job.

Desirably, the memory device stores the output condition for a particular printing job that has been performed previously and the measured results of the patch for colorimetry formed under that output condition; and the image and the patch for colorimetry are formed according to the output condition for the particular printing job stored in the memory device, and the correction data is changed when the difference between the measured results of that patch for colorimetry and the measured results stored in the memory device for the particular printing job that has been performed previously exceeds the predetermined acceptable range.

According to this mode, information relating to the output condition of a previous (past) print job which is an object of printing can be read out from the memory device and the job can be output under the same condition as the previous condition. Furthermore, the measured result when output under this condition and the previous measured result are compared, and color correction can be changed and made again if the difference between the results exceeds an acceptable range. Thereby, it is possible to match the image quality of a particular job which has been performed in the past, and it is possible to improve color reproducibility between jobs which are carried out at different times.

Furthermore, by performing similar monitoring to the above-described aspect of the invention during a job that has been started, the stability of image quality in the job is also guaranteed.

Desirably, the memory device stores the output condition and the measured results of the patch for colorimetry with respect to each printing job; and the image forming apparatus further comprises a search device which extracts information on a desired printing job from information stored in the memory device.

A desirable mode is one where the output condition and the measured result are accumulated respectively for various print jobs, the history of change thereof is stored according to requirements, and a search device which extracts required information from this stored information is provided.

Desirably, the image forming apparatus further comprises: a reading device which reads the patch for colorimetry; and a colorimetry calculation processing device which performs the colorimetry according to an image read by the reading device.

A desirable mode is one where a reading device and a colorimetry calculation processing device are provided as colorimetry devices which perform colorimetry of the patch for colorimetry. According to this mode, colorimetry of the patch for colorimetry can be performed by an in-line during the execution of a job, and automation is possible. For example, a reading device for the patch for colorimetry is disposed in the conveyance path along which the recording medium is conveyed after image formation by the recording head.

Desirably, the correction data is one of a multi-dimension look-up table, a color conversion matrix coefficient and a one-dimension look-up table.

The method of correction processing may employ various methods, and correction data corresponding to the method employed is used.

Desirably, the image forming apparatus further comprises a treatment liquid deposition device which deposits on the recording medium a treatment liquid insolubilizing or aggregating inks, wherein the recording head includes at least one inkjet head which ejects the inks with a plurality of colors onto the recording medium.

The present invention is effective when applied to an inkjet recording apparatus based on a two (or more) liquid reaction system.

Desirably, the patch for colorimetry contains single-color patches and mixed-color patches that are formed repeatedly in terms of lateral and longitudinal directions with respect to a recording area of the recording medium.

For example, in the case of a recording head which uses at least the three colors of CMY, monochrome color patches of these three colors CMY, and a gray patch formed by a composite of these three colors, are formed repeatedly in the lateral direction of the recording medium (the breadthways direction which is perpendicular to the conveyance direction) and the longitudinal direction of the recording medium (the direction parallel to the conveyance direction). If in-line determination is carried out during the execution of a printing job, a desirable mode is one where the patch for colorimetry is formed in the margins to the outside of the region (image forming region) where the print image (actual image) corresponding to the contents of the input image data is recorded.

Another aspect of the invention is directed to an image forming method comprising: a color correction processing step of performing a color correction processing with respect to an input image data; an image output control step of controlling the recording head according to the image data after performing the color correction processing in such a manner that the image corresponding to the image data is formed on the recording medium; a patch forming control step of controlling the recording head so as to form a patch for colorimetry on the recording medium; a memory step of storing in a memory device an output condition for forming the image, and measured results of the patch for colorimetry formed under the output condition; and a correction data change step of changing a correction data used for the color correction processing performed in the color correction processing step, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

According to this aspect of the present invention, it is possible to obtain stable image quality (color stability, density, and the like) within the same job. Furthermore, it is also possible to reproduce satisfactorily the image quality of a printed item obtained in a particular job carried out in the past.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus comprising:
a recording head for forming an image on a recording medium;
a color correction processing device which performs a color correction processing with respect to an input image data;
an image output controller which controls the recording head according to the image data after the color correction processing in such a manner that the image corresponding to the image data is formed on the recording medium;
a patch forming controller which controls the recording head so as to form a patch for colorimetry on the recording medium;
a memory device for storing an output condition for forming the image, and measured results of the patch for colorimetry formed under the output condition; and
a correction data change device which changes a correction data used for the color correction processing performed by the color correction processing device, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.

2. The image forming apparatus as defined in claim 1, wherein:
the memory device stores, before starting of the printing job, the output condition under which the image having an intended image quality has been formed and the measured results of the patch for colorimetry formed under the output condition; and
the patch for colorimetry is formed and the colorimetry of that formed patch is performed during performing the printing job, and the correction data is changed when the difference between the measured results of that performed colorimetry and the measured results stored in the memory device before starting of the printing job exceeds the predetermined acceptable range.

3. The image forming apparatus as defined in claim 1, wherein:
the memory device stores the output condition for a particular printing job that has been performed previously and the measured results of the patch for colorimetry formed under that output condition; and
the image and the patch for colorimetry are formed according to the output condition for the particular printing job stored in the memory device, and the correction data is changed when the difference between the measured results of that patch for colorimetry and the measured results stored in the memory device for the particular printing job that has been performed previously exceeds the predetermined acceptable range.

4. The image forming apparatus as defined in claim 1, wherein:
the memory device stores the output condition and the measured results of the patch for colorimetry with respect to each printing job; and
the image forming apparatus further comprises a search device which extracts information on a desired printing job from information stored in the memory device.

5. The image forming apparatus as defined in claim 1, further comprising:
a reading device which reads the patch for colorimetry; and
a colorimetry calculation processing device which performs the colorimetry according to an image read by the reading device.

6. The image forming apparatus as defined in claim 1, wherein the correction data is any of a multi-dimension look-up table, a color conversion matrix coefficient and a one-dimension look-up table.

7. The image forming apparatus as defined in claim 1, further comprising a treatment liquid deposition device which deposits on the recording medium a treatment liquid for insolubilizing or aggregating inks,
wherein the recording head includes at least one inkjet head which ejects the inks with a plurality of colors onto the recording medium.

8. The image forming apparatus as defined in claim 1, wherein the patch for colorimetry contains single-color patches and mixed-color patches that are formed repeatedly in terms of lateral and longitudinal directions with respect to a recording area of the recording medium.

9. The image forming apparatus as defined in claim 8, wherein the single-color patches includes patches having different gradation.

10. The image forming apparatus as defined in claim 1, further comprising a discharge route switching device which switches a discharge route of the recording medium on which the image has been formed, according to whether or not the difference between the measured results of the patch for colorimetry exceeds the predetermined acceptable range.

11. The image forming apparatus as defined in claim 1, further comprising a halftone processor which performs halftone processing with respect to the image data.

12. The image forming apparatus as defined in claim 1, wherein the patch forming controller controls the recording head so as to form the patch for colorimetry on a margin of the recording medium where the image do not formed.

13. An image forming method comprising:
a color correction processing step of performing a color correction processing with respect to an input image data;
an image output control step of controlling a recording head according to the image data after the color correction processing in such a manner that an image corresponding to the image data is formed on a recording medium;
a patch forming control step of controlling the recording head so as to form a patch for colorimetry on the recording medium;
a memory step of storing in a memory device an output condition for forming the image, and measured results of the patch for colorimetry formed under the output condition; and
a correction data change step of changing a correction data used for the color correction processing performed in the color correction processing step, when difference between the measured results of the patch for colorimetry that are obtained by forming the patch for colorimetry and performing colorimetry of that formed patch before starting of a printing job or during performing the printing job and the measured results of the patch for colorimetry that are stored in the memory device exceeds a predetermined acceptable range.
